(19) United States
(12) Patent Application Publication
(10) Pub. No.: US 2008/0207284 A1
(43) Pub. Date: Aug. 28, 2008

(54) SLIDING MECHANISM WITH UNDULATING SPRING FOR USE IN HANDHELD ELECTRONIC DEVICES

(75) Inventors: Young-Seok Jung, Goyang-Si (KR); Woog-Soo Shin, Pyeongtaek-Si (KR); Jae-Ku Jun, Gimpo-Si (KR); Jong-Woong Kang, Suwon-Si (KR)

Correspondence Address: KNOBBE MARTENS OLSON & BEAR LLP, 2040 MAIN STREET, FOURTEENTH FLOOR, IRVINE, CA, 92614, US

(73) Assignee: AMPHENOL PHOENIX CO., LTD., HWASEONG-SI (KR)

(21) Appl. No.: 12/052,434

(22) Filed: Mar. 20, 2008

Related U.S. Application Data
(63) Continuation of application No. PCT/KR2005/003155, filed on Sep. 23, 2005.

(51) Int. Cl. H04M 1/00; H04B 1/38

(52) U.S. Cl. 455/575.4; 455/566; 361/681; 361/679

(57) ABSTRACT

Disclosed is a handheld electronic device including a sliding mechanism configured to interconnect a first body and a second body such that the first and second bodies are slidable with reference to the other. The sliding mechanism includes a first sliding member configured to be secured to the first body and a second sliding member configured to be secured to the second body, the second sliding member slidably engaged with the first sliding member and slidable relative to the first sliding member between a first position and a second position. The device further has a spring comprising an undulating portion interposed between a first point and a second point of the spring's wire. The first point is secured to the first sliding member, and the second point is secured to the second sliding member. The undulating portion is configured to be compressed and released as the first sliding member slides between the first and second positions.

### CROSS-REFERENCE TO RELATED PATENT APPLICATIONS

This application is a continuation application under 35 U.S.C. §365(c) of International Application No. PCT/KR2005/003155, filed Sep. 23, 2005 designating the United States. International Application No. PCT/KR2005/003155 was published in English as WO2007/035008 A1 on Mar. 29, 2007. This application incorporates herein by reference the International Application No. PCT/KR2005/003155 including the International Publication No. WO2007/035008 A1 in its entirety.

### BACKGROUND

1. Field

The present disclosure relates to a sliding mechanism, and more particularly, to a sliding mechanism for use in a handheld electronic device.

2. Discussion of the Related Technology

FIG. 33 schematically shows a typical sliding type opening and closing apparatus mounted to a portable telephone. Referring to FIG. 33, a portable telephone 12a comprises first and second units 14a and 16a that are shown in dotted lines. In general, the first unit 14a is provided with a keypad, while the second unit 16a is provided with a liquid crystal display. The first and second units 14a and 16a are movably coupled with each other by means of an opening and closing apparatus 10a. The opening and closing apparatus 10a includes a support 20a fixed to the first unit 14a, two movable rods 40a serving as two sliders fixed respectively to both sides of the second unit 16a, and a torsion spring 50a. Although it has not been shown in detail, guide rails are provided on both sides of the support 20a and the two movable rods 40a are fitted into the relevant guide rails to be linearly moved along the guide rails. Two connecting portions of the torsion spring 50a are connected to the support 20a and the movable rod 40a, respectively. As the two movable rods 40a are linearly moved along the guide rails of the support 20a, the keypad of the first unit 14a is exposed or closed. At this time, the torsion spring 50a allows the second unit 16a to be automatically opened or closed after the second unit 16a is moved by a predetermined degree.

The foregoing discussion is to provide general background information, and does not constitute an admission of prior art.

### SUMMARY

One aspect of the invention provides a handheld electronic device comprising a sliding mechanism configured to interconnect a first body and a second body such that the first and second bodies are slidable with reference to the other, wherein the sliding mechanism may comprise: a first sliding member configured to be secured to the first body, a second sliding member configured to be secured to the second body, the second sliding member slidably engaged with the first sliding member and slidable relative to the first sliding member between a first position and a second position; and a spring comprising an undulating portion interposed between a first point and a second point of the spring's wire, the first point being secured to the first sliding member, the second point being secured to the second sliding member, wherein the undulating portion is configured to be compressed and released as the first sliding member slides between the first and second positions.

In the foregoing device, the undulating portion may comprise a plurality of alternating hills and valleys, wherein two immediately neighboring hills form a first gap therebetween, and two immediately neighboring valleys form a second gap therebetween. At least part of the hills and valleys may comprise a U-turn of the wire. At least part of the hills and valleys may comprise a circular turning of the wire. The hills and valleys may be generally in the same size. At least one of the hills and valleys may have a size significantly different from another of the hills and valleys. The undulating portion may be configured such that the second gap becomes smaller as the undulating portion is compressed. The undulating portion may be configured such that the first gap becomes larger as the second gap becomes smaller. At least one of the hills may comprise a circular turning of the wire. The first gap may be the largest when the first sliding member is at the first or second position.

Still in the foregoing device, the undulating portion may further comprise a plurality of extensions, each between a hill and a valley immediately neighboring the hill. The plurality of extensions may be in generally the same length. At least one of the plurality of extensions may have a length significantly different from another of the plurality of extensions. At least part of the plurality of extensions may be substantially straight. At least two of the plurality of extensions may be generally curved while generally parallel with each other.

Further in the foregoing device, the spring may comprise the undulating portion substantially throughout between the first and second points. The undulating portion may be only a part between the first and second points of the spring. The spring may comprise at least one additional undulating portion between the first and second points. The spring may further comprise at least one circular turning between the first and second points. The undulating portion may comprise a plurality of first U-turns and a plurality of second U-turns generally in an opposite direction of the plurality of first U-turns, wherein the plurality of first and second U-turns may be alternatingly arranged such that two neighboring first U-turns form a first gap therebetween and two neighboring second U-turns form a second gap therebetween. The wire of the spring may be press-produced. The undulating portion may be substantially in a single plane. The undulating portion may be configured to be compressed and released while substantially staying in the single plane. The spring may comprise another undulating portion interposed between the second point and a third point of the spring's wire, the third point being secured to the first sliding member, wherein the additional undulating portion may be configured to be compressed and released as the first sliding member slides between the first and second positions.

An aspect of the present invention is to provide a sliding type opening and closing apparatus capable of opening or closing at least portions of two units by allowing the two units to be coupled with each other and to be slid relative to each other. Another aspect of the present invention is to provide a sliding type opening and closing apparatus for use in a portable telephone with improved durability. A further aspect of the present invention is to provide a sliding type opening and closing apparatus that is accurately operated. A still further aspect of the present invention is to provide a sliding type opening and closing apparatus of small thickness.

An aspect of the present invention provides a sliding type opening and closing apparatus for coupling first and second units moved relative to each other and causing at least a portion of the first or second unit to be opened or closed through a relative sliding movement between the first and second units. The opening and closing apparatus comprises a first linking member linked to the first unit; a second linking member linked to the second unit and slid with respect to the first linking member; a movable member movably connected to the first and second linking members; and a resilient member for imparting a force to the movable member in a direction substantially perpendicular to a direction in which the first and second link members are slid, wherein the first linking member includes a first guide track extending in a direction substantially perpendicular to the sliding direction of the first and second linking members to guide the movement of the movable member with respect to the first linking member, and the second linking member includes a second guide track extending between two points along the sliding direction of the first and second linking members to guide the movement of the movable member with respect to the second linking member and being inclined toward a direction of the force imparted by the resilient member with respect to the sliding direction as the second track runs toward its opposite ends.

The first linking member may further include a third guide track spaced apart from the first guide track in a direction perpendicular to the sliding direction while the second linking member may further include a fourth guide track spaced apart from the second guide track in a direction perpendicular to the slide movement direction, and the apparatus further comprises another movable member interacting with the third guide track of the first linking member and the fourth guide track of the second linking member. Preferably, the resilient member is a tensile coil spring and both ends of the tensile coil spring are connected to the two movable members, respectively.

Another aspect of the present invention provides a sliding type opening and closing apparatus for coupling first and second units moved relative to each other and causing at least a portion of the first or second unit to be opened or closed through relative movement between the first and second units. The opening and closing apparatus comprises a first linking member linked to the first unit; a second linking member linked to the second unit and slid with respect to the first linking member, the second linking member including a rack extending in a sliding direction of the second linking member; a pinion gear engaged with the rack; and a torsion spring including both ends connected respectively to the pinion gear and the first linking member, whereby a distance between both ends can be changed as the pinion gear rotates. Preferably, a rotating shaft of the pinion gear is coupled to the first linking member.

The second linking member may further include a second rack formed to face the rack, and the opening and closing apparatus may further comprise a second pinion gear engaged with the second rack of the second linking member and the pinion gear and formed with a rotating shaft thereof coupled with the first linking member. The first linking member may include a third rack formed opposite to the rack of the second linking member and engaged with the pinion gear.

Preferably, two columns protruding in a rotating axis of the pinion gear are provided on opposite sides of the pinion gear, respectively, and the first and second linking members are provided with guide portions which extend in the sliding direction and in which the two columns of the pinion gear are movably received. Preferably, the columns of the pinion gear are caught into opposite ends of the guide portions of the first and second linking members to limit their movements.

A further aspect of the present invention provides a sliding type opening and closing apparatus for coupling first and second units moved relative to each other and causing at least a portion of the first or second unit to be opened or closed through relative movement between the first and second units. The opening and closing apparatus comprises a first linking member linked to the first unit; a second linking member linked to the second unit and slid with respect to the first linking member; and a resilient member connected to the first and second linking members, wherein the resilient member imparts a force to the linking members in a direction in which its portions connected to the first and second linking members move away from each other. The resilient member may be formed into a zigzag shape and include linear extension portions and curved portions.

Preferably, the resilient member is a compression spring, both longitudinal ends of the resilient member are connected respectively to both sides of the first linking member on an extension line substantially perpendicular to a direction in which the second linking member is slid with respect to the first linking member, and a middle portion of the resilient member is restrained by the second linking member.

Preferably, both longitudinal ends of the resilient member are connected respectively to the first and second linking members, and curved portions on one lateral side among a plurality of curved portions formed on both lateral sides of the resilient member are always kept closer than curved portions on the other lateral side as the first and second linking members are moved relative to each other. Preferably, at least one of the curved portions of the resilient member is formed into a coil.

Preferably, at least one curved portion formed into a coil is arranged in the middle of curved portions formed on the relatively wider lateral side among the plurality of curved portions formed on the lateral sides. Preferably, at least one curved portion formed into a coil is arranged at opposite ends of curved portions formed on the relatively wider lateral side among the plurality of curved portions formed on the lateral sides.

The opening and closing apparatus of the present invention may further comprise another resilient member connected to the first and second linking members to be crossed with the resilient member, wherein the other resilient member is substantially similar to the resilient member in view of their shapes. The two resilient members may be substantially symmetrical with respect to a central axis extending in a direction in which the linking members are slid relative to each other.

Preferably, the resilient member includes two extension portions, two first connecting portions are provided respectively to both ends of the two extension portions, a second connecting portion formed into a coil is provided between the two extension portions, and one of the first and second connecting portions is connected to the first linking member while the other is connected to the second linking member. The two extension portions may be curved to be concave on sides facing each other. The two extension portions may be curved into a zigzag shape.

Preferably, the resilient member includes two or more extension portions substantially parallel to each other which are formed by curving a wire rod, two or more first connecting portions formed into a coil are provided on one side of the extension portions while two or more second connecting portions formed into a coil are provided on the other side of the extension portions, the plurality of extension portions are curved toward an identical direction, and one of the first and second connecting portions is connected to the first linking member while the other is connected to the second linking member.

Preferably, the resilient member includes an extension portion formed by twisting two wire rods, and first and second connecting portions provided respectively on both ends of the extension portion; and one of the first and second connecting portions is connected to the first linking member while the other is connected to the second linking member.

Preferably, the resilient member includes a long extension portion, and first and second connecting portions provided respectively at both ends of the extension portion; the extension portion is inclined to gradually move away from a straight line connecting the first and second connecting portions as it goes from the first and second connecting portions toward its middle portion and a concave portion protruding toward the straight line connecting the two connecting portions is formed in the middle of the extension portion; and one of the first and second connecting portions is connected to the first linking member while the other is connected to the second linking member.

A sliding type opening and closing apparatus capable of opening or closing at least portions of two units by allowing the two units to be coupled with each other and to be slid relative to each other can be provided. The sliding operation of the opening and closing apparatus with a pinion gear can be precise. The opening and closing apparatus with a resilient member made of a thin wire rod can be made thinner. Further, since a resilient member includes a plurality of deformable curved portions to cause elastic force to be uniformly distributed and some of the deformable curved portions are wound in the form of a coil to improve its durability, the opening and closing apparatus with the resilient member can be used for a long time.

### BRIEF DESCRIPTION OF THE DRAWINGS

FIG. 1 is a perspective view of a portable telephone that is opened and closed in a sliding mode.

FIG. 2(a) to (c) are a side view, a bottom view and a sectional view, taken along line C-C′ in FIG. 2(b), of a sliding type opening and closing apparatus according to an embodiment of the present invention, respectively, which is mounted to the portable telephone of FIG. 1, when the portable telephone has been completely closed.

FIG. 3 is a plan view of a first linking member installed to the opening and closing apparatus shown in FIG. 2.

FIG. 4 is a plan view of a second linking member installed to the opening and closing apparatus shown in FIG. 2.

FIG. 5 is an exploded perspective view of a first movable member installed to the opening and closing apparatus shown in FIG. 2.

FIG. 6(a) and (b) are side and bottom views illustrating a state of the opening and closing apparatus of FIG. 2, respectively, when the portable telephone with the opening and closing apparatus of FIG. 2 is in a neutral position where the portable telephone is being opened.

FIG. 7(a) and (b) are side and bottom views illustrating a state of the opening and closing apparatus of FIG. 2, respectively, when the portable telephone has been completely opened.

FIG. 8(a) to (c) are a side view, a bottom view and a sectional view, taken along line D-D′ in FIG. 8(b), of a sliding type opening and closing apparatus according to an embodiment of the present invention, respectively, which is mounted to the portable telephone shown in FIG. 1, when the portable telephone has been completely closed.

FIG. 9(a) and (b) are side and bottom views illustrating a state of the opening and closing apparatus of FIG. 8, respectively, when the portable telephone with the opening and closing apparatus of FIG. 8 is in a neutral position where the portable telephone is being opened.

FIG. 10(a) and (b) are side and bottom views illustrating a state of the opening and closing apparatus of FIG. 8, respectively, when the portable telephone has been completely opened.

FIG. 11(a) to (c) are a side view, a bottom view and a sectional view, taken along line E-E′ in FIG. 11(b), of a sliding type opening and closing apparatus according to an embodiment of the present invention, respectively, which is mounted to the portable telephone of FIG. 1, when the portable telephone has been completely closed.

FIG. 12 is a plan view of a first linking member installed to the opening and closing apparatus shown in FIG. 11.

FIG. 13 is a plan view of a second linking member installed to the opening and closing apparatus shown in FIG. 11.

FIG. 14(a) and (b) are side and bottom views illustrating a state of the opening and closing apparatus of FIG. 11, respectively, when the portable telephone with the opening and closing apparatus of FIG. 11 is in a neutral position where the portable telephone is being opened.

FIG. 15(a) and (b) are side and bottom views illustrating a state of the opening and closing apparatus of FIG. 11, respectively, when the portable telephone with the opening and closing apparatus of FIG. 11 has been completely opened.

FIG. 16(a) to (c) are side, plan and front views of a sliding type opening and closing apparatus according to an embodiment of the present invention, respectively, which is mounted to the portable telephone of FIG. 1, when the portable telephone has been completely closed.

FIG. 17 is a perspective view of a first linking member installed to the opening and closing apparatus shown in FIG. 16.

FIG. 18 is a perspective view of a second linking member installed to the opening and closing apparatus shown in FIG. 16.

FIG. 19(a) and (b) are side and plan views illustrating a state of the opening and closing apparatus of FIG. 16, respectively, when the portable telephone with the opening and closing apparatus of FIG. 16 is in a neutral position where the portable telephone is being opened.

FIG. 20(a) and (b) are side and plan views illustrating a state of the opening and closing apparatus of FIG. 16, respectively, when the portable telephone with the opening and closing apparatus of FIG. 16 has been completely opened.

FIG. 21(a) to (c) are side, bottom and front views of a sliding type opening and closing apparatus according to an embodiment of the present invention, respectively, which is mounted to the portable telephone of FIG. 1, when the portable telephone has been completely closed.

FIG. 22(a) and (b) are side and bottom views illustrating s state of the opening and closing apparatus of FIG. 21, respectively, when the portable telephone with the opening and closing apparatus of FIG. 21 is in a neutral position where the portable telephone is being opened.

FIG. 23(a) and (b) are side and bottom views illustrating a state of the opening and closing apparatus of FIG. 21, respectively, when the portable telephone with the opening and closing apparatus of FIG. 21 has been completely opened.

FIG. 24 is a bottom view of a sliding type opening and closing apparatus according to an embodiment of the present invention, which is mounted to the portable telephone shown in FIG. 1.

FIG. 25 is a bottom view of a sliding type opening and closing apparatus according to an embodiment of the present invention, which is mounted to the portable telephone shown in FIG. 1.

FIG. 26 is a bottom view of a sliding type opening and closing apparatus according to an embodiment of the present invention, which is mounted to the portable telephone shown in FIG. 1.

FIG. 27 is a bottom view of a sliding type opening and closing apparatus according to an embodiment of the present invention, which is mounted to the portable telephone shown in FIG. 1.

FIG. 28(a) and (b) are plan views of another embodiment of a resilient member mounted to the sliding type opening and closing apparatus shown in FIG. 21, respectively.

FIG. 29(a) and (b) are plan views of a further embodiment of a resilient member mounted to the sliding type opening and closing apparatus shown in FIG. 21.

FIG. 30(a) to (g) are plan views of a still further embodiment of a resilient member mounted to the sliding type opening and closing apparatus shown in FIG. 21, respectively.

FIG. 31 is a plan view of a still further embodiment of a resilient member mounted to the sliding type opening and closing apparatus shown in FIG. 21.

FIG. 32 is a plan view of a still further embodiment of a resilient member mounted to the sliding type opening and closing apparatus shown in FIG. 21.

FIG. 33 is a schematic plan view of a typical sliding type opening and closing apparatus that is mounted to the portable telephone.

### DETAILED DESCRIPTION OF EMBODIMENTS

Hereinafter, embodiments of the present invention will be described in detail with reference to the accompanying drawings.

A sliding type opening and closing apparatus mounted to a portable telephone should have predetermined durability. In particular, a resilient member among parts of the sliding type opening and closing apparatus should have sufficient durability to continuously perform its own inherent operation. Further, the opening and closing apparatus should be accurately operated. Furthermore, the opening and closing apparatus should be thin and compact enough to be suitable for a product such as a portable telephone that will be gradually minimized.

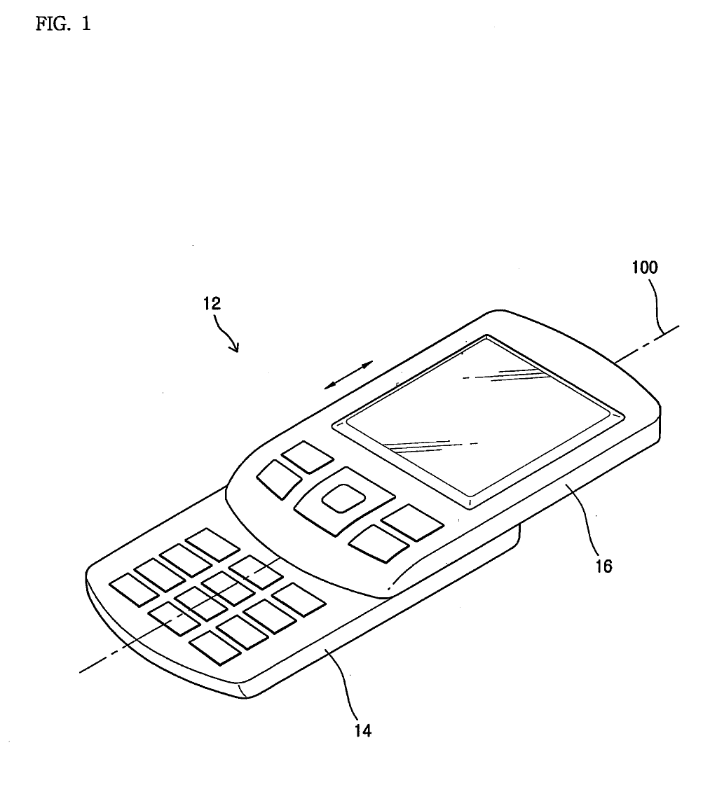

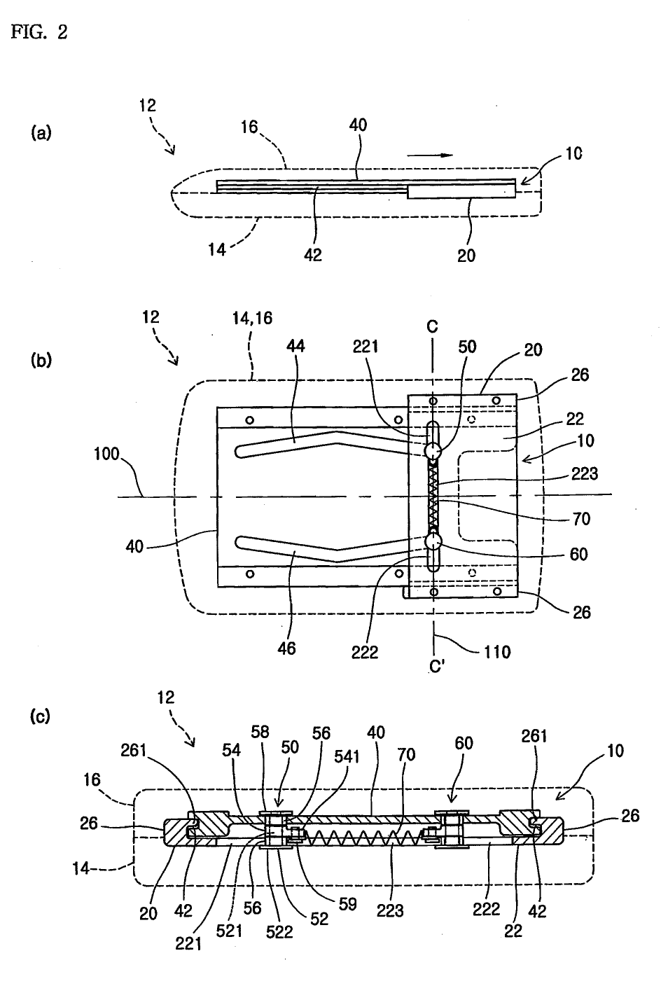

Referring to FIG. 1, a portable telephone 12 comprises a first unit 14 provided with a keypad, and a second unit 16 provided with a liquid crystal display. As shown in the figure, the second unit 16 may also be provided with buttons, if necessary. Referring also to FIG. 2(a) to (c), the first and second units 14 and 16 overlap and couple each other through an opening and closing apparatus 10 such that they can be linearly slid relative to each other along a moving axis 100.

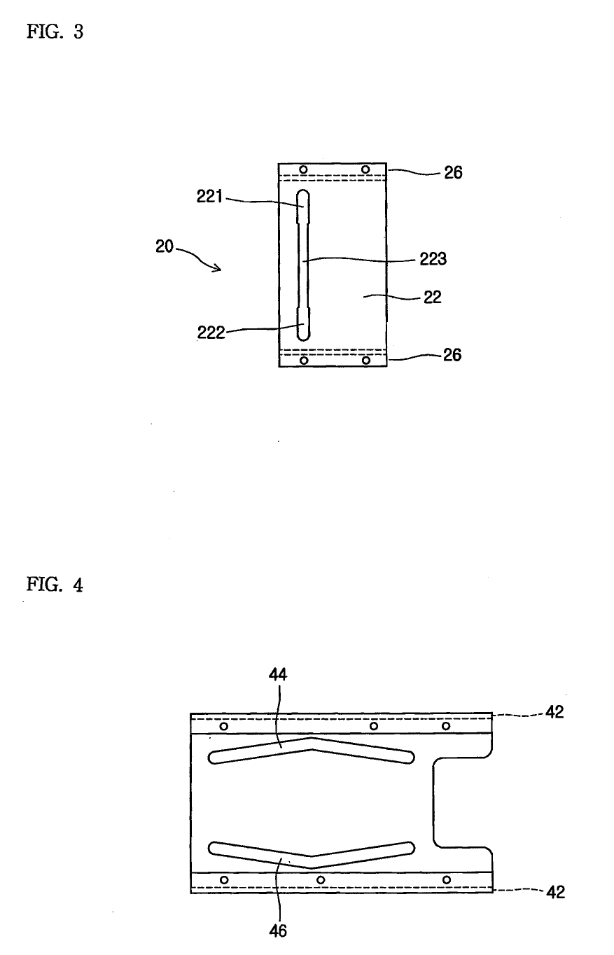

Referring to FIG. 1 and FIG. 2(a) to (c), the opening and closing apparatus 10 according to an embodiment includes a first linking member 20 linked to the first unit 14 of the portable telephone 12, a second linking member 40 linked to the second unit 16 of the portable telephone 12, a first movable member 50, a second movable member 60, and a resilient member 70. Referring to FIG. 2(a) to (c) and FIG. 3, the first linking member 20 is shaped as a generally rectangular plate and includes a flat base plate 22 and a pair of guide rails 26 extending in a direction parallel to the moving axis 100 on both sides of the base plate 22 and formed to slightly protrude toward the second unit 16.

The base plate 22 has first and second guide portions 221 and 222 that are positioned near the guide rails and extend in a direction perpendicular to the moving axis 100. The first and second guide portions 221 and 222 are positioned on the same extension line 110. As shown in the figures, the first and second guide portions 221 and 222 are formed into perforated tracks that are formed by perforating the base plate 22 at a predetermined width. The first and second movable members 50 and 60 can be moved along the first and second guide portions 221 and 222, respectively. Between the first and second guide portions 221 and 222 is provided a connecting portion 223 that perforates the base plate 22 and connects the first and second guide portions 221 and 222. The width of the connecting portion 223 is smaller than those of the first and second guide portions 221 and 222. This is to prevent the first and second guide portions 221 and 222 from being moved into the connecting portion 223. Meanwhile, in a space defined by the connecting portion 223 is positioned the resilient member 70 for connecting the first and second guide portions 221 and 222. The two guide rails 26 are provided with linking wings 261 which are slightly spaced apart from the surface of the base plate 22 and protrude to face each other. The linking wings 261 are fitted into two linking grooves 42 of the second linking member 40, respectively, as described later.

Referring to FIG. 2(a) to (c) and FIG. 4, the second linking member 40 is shaped as a rectangular plate generally extending along the moving axis 100. The linking grooves 42 in which the linking wings 261 of the two guide rails 26 of the first linking member 20 can be slid, respectively, are provided on both sides of the second linking member 40 extending in a direction parallel to the moving axis 100. The two linking wings 261 of the first linking member 20 are fitted into the two linking grooves 42 of the second linking member 40, respectively, such that the first and second linking members 20 and 40 can be linearly slid relative to each other along the moving axis 100 without being separated from each other. The second linking member 40 is provided with third and fourth guide portions 44 and 46 that are positioned near the linking grooves 42 and substantially extend in a direction parallel to the moving axis 100 to be symmetrical to each other. The third and fourth guide portions 44 and 46 are formed into perforated tracks that are formed by perforating the second linking member 40. The third and fourth guide portions 44 and 46 have track portions which are slightly inclined from the moving axis 100 such that the track portions can be far away from each other as they run toward their middle points. The first and second movable members 50 and 60 can be moved along the third and fourth guide portions 44 and 46, respectively.

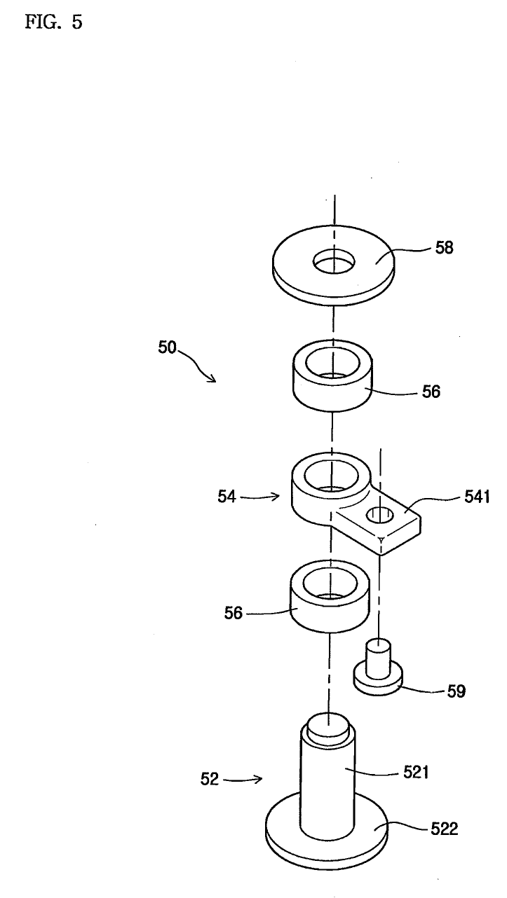

Referring to FIG. 2(c) and FIG. 5, the first movable member 50 includes a rivet 52, a support member 54, two rollers 56 and a coupling ring 58. The rivet 52 is fitted into the first guide portion 221 of the first linking member 20 and the third guide portion 44 of the second linking member 40 such that a column 521 of the rivet 52 can pass through the first and second guide portions. The rivet 52 is not separated from the first and third guide portions 221 and 44 by means of the head of the rivet 52 and the coupling ring 58 coupled to a tip end of the rivet 52 opposite to the rivet head. The two rollers 56 are fitted around the column 521 of the rivet 52 and roll along the first guide portion 221 of the first linking member 20 and the third guide portion 44 of the second linking member 40 to reduce friction between the roller and relevant guide portion when the second linking member 40 is moved in the first and third guide portions 221 and 44. The support member 54 is fitted around the column 521 of the rivet 52 at its middle point. The support member 54 is provided with a coupling portion 541 extending toward the second guide portion 222 of the first linking member 20. To the coupling portion 541 is coupled a coupling rivet 59 to which one end of the resilient member 70 is fixed.

Since the second movable member 60 has the same configuration as the first movable member 50, a detailed description thereof will be omitted herein. It can be understood by a person skilled in the art that the first and second movable members 50 and 60 are moved far away from or close to each other along the first and second guide portions 221 and 222 of the first linking member 20 by means of the third and fourth guide portions 44 and 46 of the second linking member 40 when the second linking member 40 is moved along the moving axis 100 with respect to the first linking member 20.

The resilient member 70 is a tension coil spring and both ends of the resilient member are connected to the first and second movable members 50 and 60, respectively. Therefore, the first and second movable members 50 and 60 are forced to be close to each other by means of the resilient member 70.

Hereinafter, the operation of an embodiment will be described in detail with reference to FIGS. 2, 6 and 7. Referring first to FIG. 2(a) and (b), the portable telephone 12 is completely closed. At this time, the first and second movable members 50 and 60 of the opening and closing apparatus 10 are positioned at ends of the third and fourth guide portions 44 and 46 of the second linking member 40, respectively, to thereby limit the movement of the first and second movable members 50 and 60 such that the first and second movable members 50 and 60 cannot be moved toward each other. Furthermore, the resilient member 70 pulls the first and second movable members 50 and 60 such that the movable members can be moved toward each other. In order to open the portable telephone 12, the second linking member 40 linked to the second unit 16 is moved such that the first and second movable members 50 and 60 move away from each other. Thus, the portable telephone 12 is stably kept at a closed state when no external force is exerted thereto.

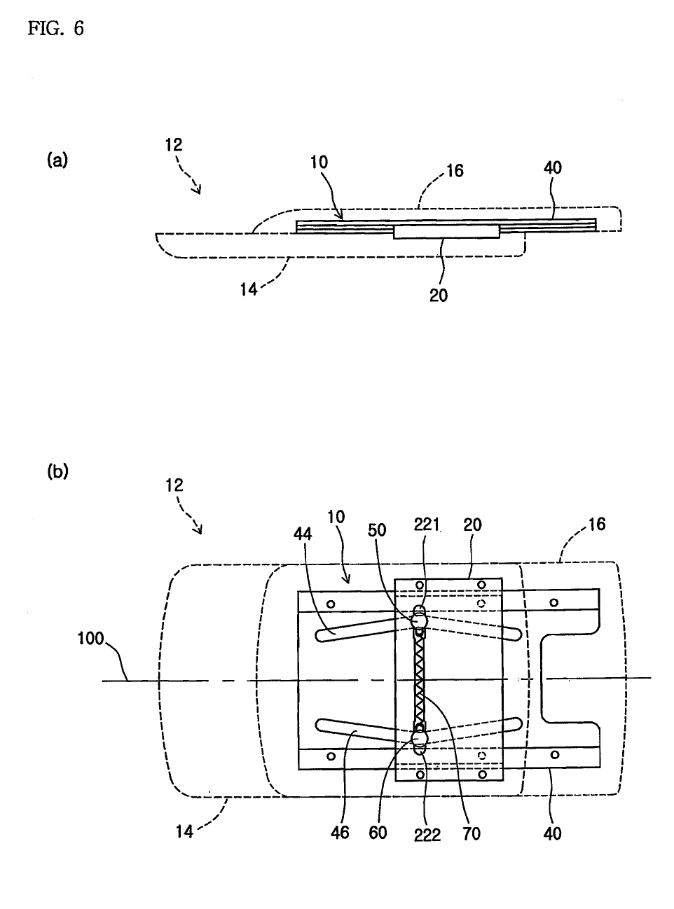

In order to open the portable telephone 12 at a state shown in FIG. 2(a) and (b), an external force is applied to the portable telephone such that the second unit 16 can be pushed in a direction indicated by the arrow (rightward in this figure). Then, the external force allows the second linking member 40 of the opening and closing apparatus 10 to be moved rightward, and thus, the first and second movable members 50 and 60 can be moved along the first and second guide portions 221 and 222 of the first linking member 20, respectively, to thereby move away from each other against the resilient force of the resilient member 70. FIG. 6(a) and (b) show a state where the portable telephone 12 continues to be opened and the first and second movable members 50 and 60 are then in a neutral position where the movable members are positioned in the middle of the first and second guide portion 221 and 222 of the first linking member 20, respectively. If the external force is removed before the first and second movable members 50 and 60 arrives at the neutral position, the resilient force of the resilient member 70 causes the first and second movable members 50 and 60 to be moved towards each other. As a result, the second linking member 40 is automatically moved leftward, and thus, the opening and closing apparatus 10 is also automatically closed.

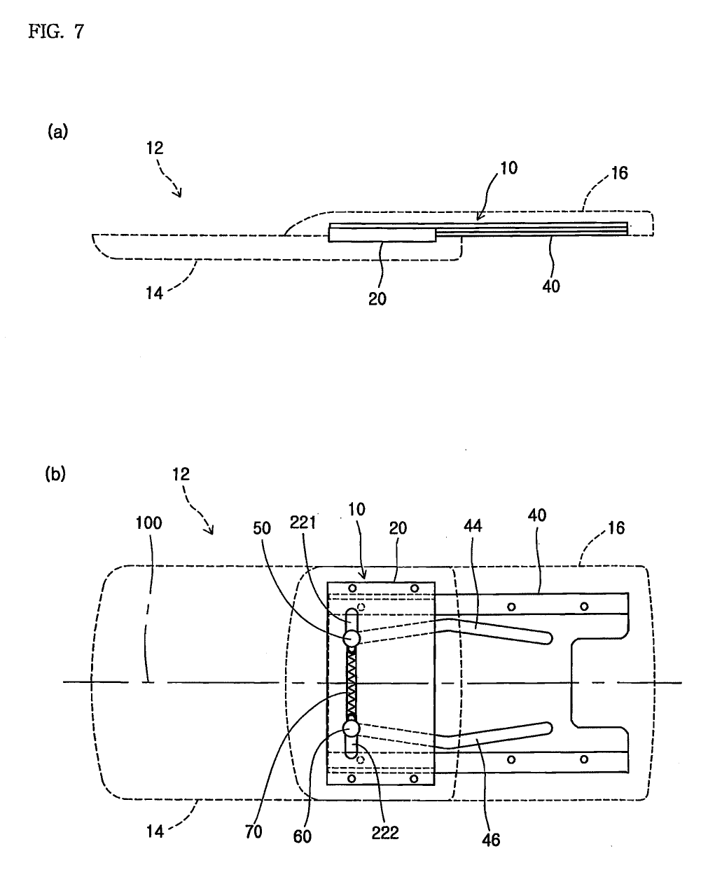

If the second unit 16 is pushed rightward from the state shown in FIG. 6(a) and (b) to further open the opening and closing apparatus 10, the first and second movable members 50 and 60 of the opening and closing apparatus 10 pass through the neutral positions, i.e. middle points of the third and fourth guide portions 44 and 46 of the second linking member 40, to inclined points of the guide portions. Even though there is no external force at this state, the resilient force of the resilient member 70 causes the first and second movable members 50 and 60 to move toward each other and thus causes the second linking member 40 to be automatically moved rightward. If the first and second movable members 50 and 60 move rightward and stop at the left side ends of the third and fourth guide portions 44 and 46 of the second linking member 40, respectively. Such a state is shown in FIG. 7(a) and (b). In order to again close the portable telephone 12 at this state, an external force is applied to the portable telephone until the portable telephone is in a state shown in FIG. 6(a) and (b). Then, the portable telephone 12 is automatically closed as described above.

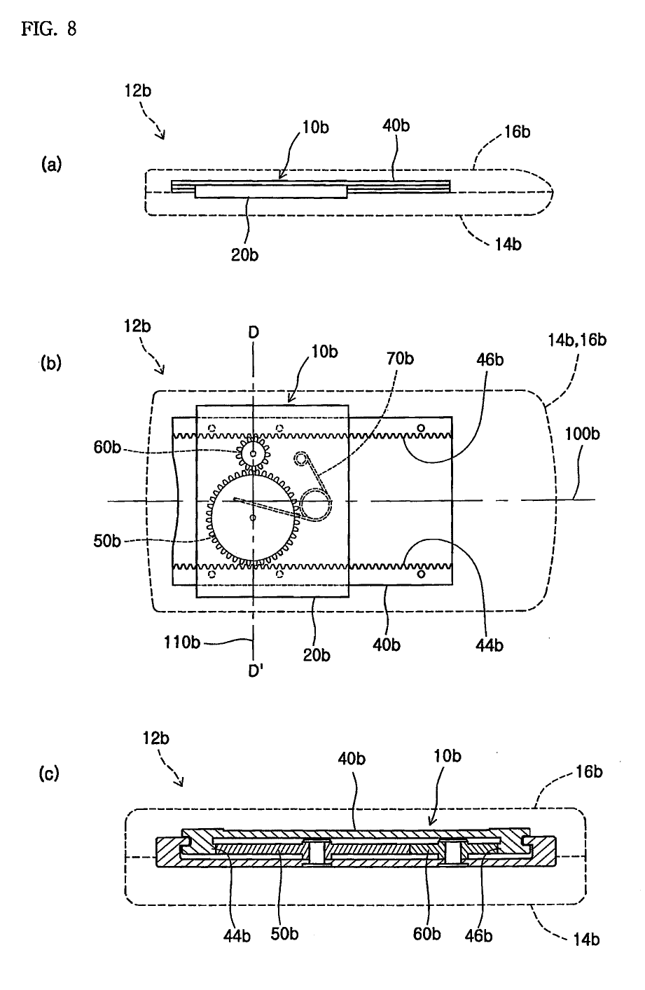

FIGS. 8 to 10 show an opening and closing apparatus 10b according to an embodiment of the present invention. Referring to FIG. 8(a) to (c), the opening and closing apparatus 10b includes a first linking member 20b linked to a first unit 14b of a portable telephone 12b, a second linking member 40b linked to a second unit 16b of the portable telephone 12b, a first pinion gear 50b, a second pinion gear 60b and a resilient member 70b. If the first linking member 20b is compared with the first linking member 20 shown in FIG. 2, their configurations are substantially identical to each other except that the first and second guide portions 221 and 222 and the connecting portion 223 are not formed on the base plate of the first linking member 20b. Therefore, detailed descriptions thereof will be omitted herein.

The second linking member 40b includes first and second racks 44b and 46b extending along a moving axis 100b at opposite positions on both linking grooves. The first rack 44b is engaged with the first pinion gear 50b, and the second rack 46b is engaged with the second pinion gear 60b. If the second linking member 40b is compared with the second linking member 40 shown in FIG. 2, their configurations are substantially identical to each other except that the third and fourth guide portions are not provided in the second linking member 40b. Therefore, detailed descriptions thereof will be omitted herein.

The first and second pinion gears 50b and 60b are installed to the first linking member 20b such that they can be engaged with each other. The respective rotating centers of the first and second pinion gears 50b and 60b are located on an extension line 110b perpendicular to the moving axis 100b. However, the present invention is not limited thereto. The radius of the first pinion gear 50b is larger than that of the second pinion gear 60b. Although it has been illustrated in FIGS. 8 to 10 that the first pinion gear 50b is larger than the second pinion gear 60b, it will be understood by those skilled in the art that the sizes of the first and second pinion gears 50b and 60b can be changed depending on the widths of the first and second units 14b and 16b and the traveling distance between the first and second units 14b and 16b. The first and second pinion gear 50b and 60b are engaged with the first and second racks 44b and 46b of the second linking member 40b, respectively. If the first and second pinion gears 50b and 60b are engaged and rotated with each other, the first and second linking members 20b and 40b are moved relative to each other along the moving axis 100b.

The resilient member 70b is a torsion spring, and one end of the resilient member 70b is rotatably connected to the first linking member 20b and the other end thereof is rotatably connected to the first pinion gear 50b. It will be understood by those skilled in the art that one end is connected to the first linking member 20b to be rotatably fitted around a boss installed on the first linking member 20b and the other end is connected to the first pinion gear 50b to be rotatably fitted into a hole formed on the first pinion gear 50b. An elastic force of the resilient member 70b imparts the rotational force to the first pinion gear 50b.

Hereinafter, the operation of the opening and closing apparatus 10b according to an embodiment will be described in detail with reference to FIGS. 8 to 10. First, referring to FIG. 8(a) and (b), in a state where the portable telephone 12b is completely closed, the direction of the rotational force applied to the first pinion gear 50b by the resilient member 70b of the opening and closing apparatus 10b corresponds to a direction in which the second linking member 40b is moved to close the portable telephone 12b. However, since the portable telephone 12b has been completely closed, it is reliably kept in its closed state in such a manner that its movement is limited by a structure such as a stopper (not shown).

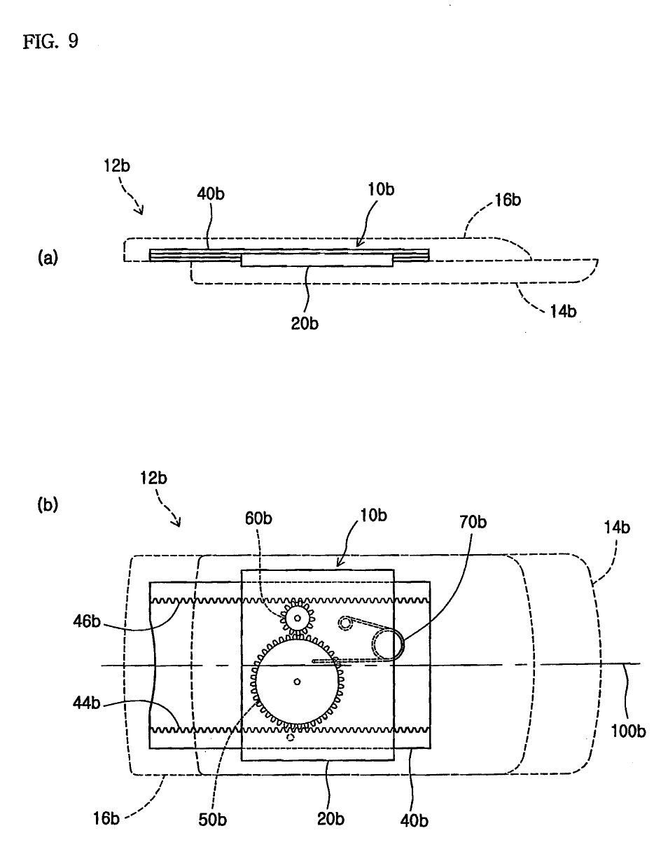

In order to open the portable telephone 12b at a state shown in FIG. 8(a) and (b), an external force is applied to push the second unit 16b in a direction indicated by an arrow (leftward in this figure). Then, the external force causes the second linking member 40b of the opening and closing apparatus 10b to be moved leftward, and thus, the first and second pinion gears 50b and 60b to be rotated. At this time, one end of the resilient member 70b which is connected to the first pinion gear 50b is also rotated together with the first pinion gear 50b, and a distance between both ends of the resilient member 70b are decreased. FIG. 9(a) and (b) show a state where the second unit 16b of the portable telephone 12b continues to be pushed leftward and is then in a neutral position where the distance between the both ends of the resilient member 70b is minimized. If the external force is removed before the second unit 16b is in the neutral position shown in FIG. 9(a) and (b), the force for increasing the distance between both ends of the resilient member 70b causes the first pinion gear 50b to be rotated in the opposite direction, and thus, the second linking member 40b to be automatically moved rightward. Therefore, the portable telephone 12b can be automatically closed.

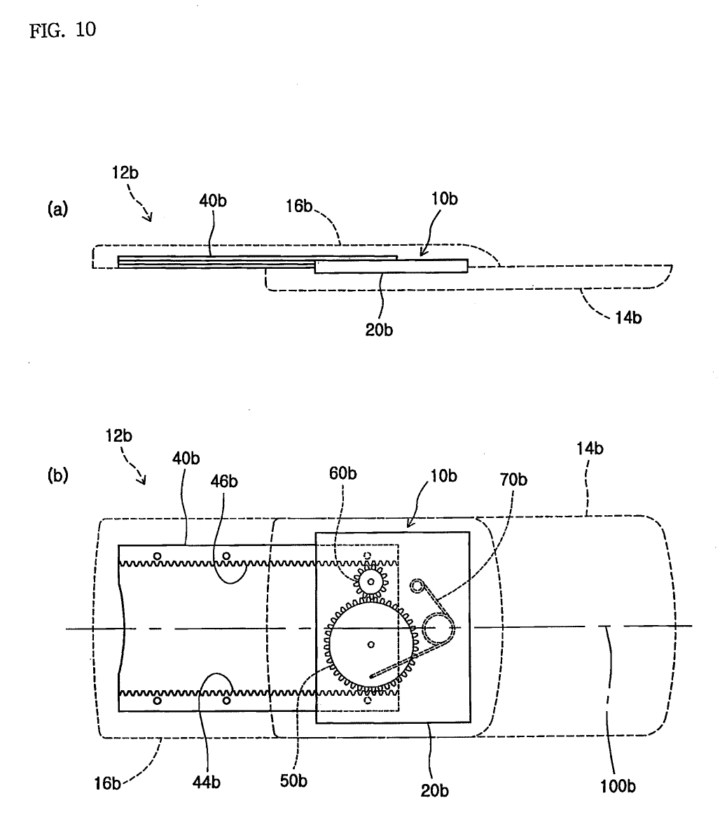

If the second unit 16b is pushed leftward to further open the portable telephone 12b at a state shown in FIG. 9(a) and (b), the resilient member 70b applies a force for causing the first pinion gear 50b to rotate along a direction in which the second linking member 40b is forced to move leftward. This resilient force of the resilient member 70b can cause the second linking member 40b to be automatically moved leftward without an additional external force. When the portable telephone 12b is kept completely open as shown in FIG. 10(a) and (b), the second linking member 40b is stopped by a structure such as a stopper (not shown).

Referring to FIG. 10(a) and (b), the direction of the rotational force applied to the first pinion gear 50b by the resilient member 70b of the opening and closing apparatus 10b corresponds to a direction in which the second linking member 40b is moved to open the portable telephone 12b. However, since the portable telephone 12b has been already completely opened, it is reliably kept in its open state in such a manner that its movement is limited by a structure such as the stopper (not shown).

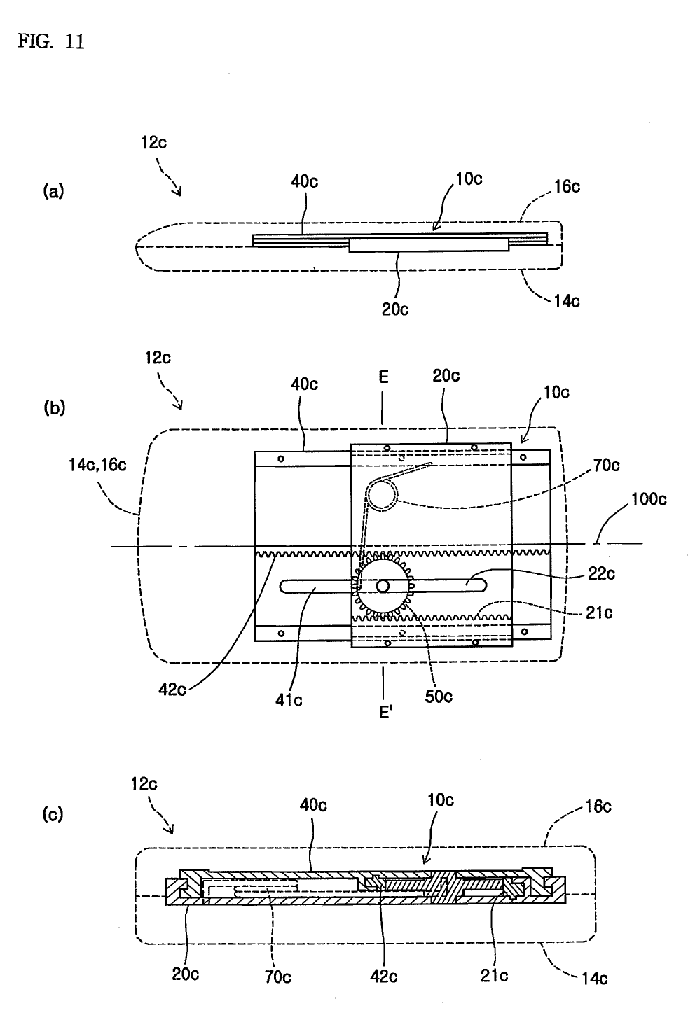

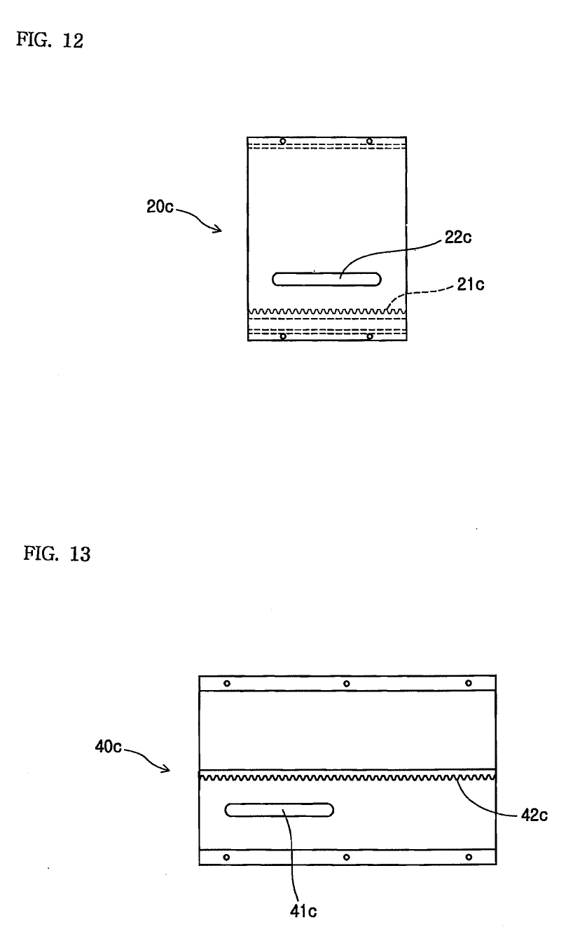

FIGS. 11 to 15 show an opening and closing apparatus 10c according to an embodiment of the present invention. Referring to FIG. 11(a) to (c), the opening and closing apparatus 10c includes a first linking member 20c linked to a first unit 14c of a portable telephone 12c, a second linking member 40c linked to a second unit 16c of the portable telephone 12c, a pinion gear 50c and a resilient member 70c. Referring to FIG. 11(a) to (c) and FIG. 12, the first linking member 20c is generally shaped as a rectangular plate and a first rack 21c extending in a direction parallel to a moving axis 110c is provided at one side of the first linking member 20c. The first rack 21c is engaged with the pinion gear 50c. The first linking member 20c is provided with a first guide portion 22c that is formed to extend in a direction parallel to the moving axis 100c along a line spaced apart from the first rack 21c toward the center of the first linking member. The first guide portion 22c is formed by perforating the first linking member 20c. One end of a rotating shaft 51c of the pinion gear 50c is inserted into the first guide portion 22c. The first guide portion 22c guides and limits the linear movement of the pinion gear 50c. The other configurations (for example, guide tracks, linking wings, etc.) of the first linking member 20c are identical to those of the first linking member 20b of an embodiment shown in FIG. 8 except that their fixing positions are different from each other as described later. Therefore, detailed descriptions thereof will be omitted herein.

Referring to FIG. 11(a) to (c) and FIG. 13, the second linking member 40c is provided with a second guide portion 41c that has the same shape as the first guide portion 22c of the first linking member 20c. The second guide portion 41c is positioned on the same extension line as the first guide portion 22c when the first linking member 20c is coupled with the second linking member 40c. The other end of the rotating shaft 51c of the pinion gear 50c is inserted into the second guide portion 41c. The second guide portion 41c guides and limits the linear movement of the pinion gear 50c. The second linking member 40c is provided with a second rack 42c that extends in a direction parallel to the moving axis 100c along a line spaced apart from the second guide portion 41c toward the center of the second linking member and faces the first rack 21c of the first linking member 20c. The second rack 42c is engaged with the pinion gear 50c together with the first rack 21c. The other configurations (for example, linking grooves etc.) of the second linking member 40c are identical to those of the second linking member 40b of an embodiment shown in FIG. 8. Therefore, detailed descriptions thereof will be omitted herein.

The pinion gear 50c is engaged with the first rack 21c of the first linking member 20c and the second rack 42c of the second linking member 40c. As the pinion gear 50c is rotated, the first and second linking members 20c and 40c are moved relative to each other along the moving axis 100c. Both ends of the rotating shaft 51c of the pinion gear 50c are inserted into the first guide portion 22c of the first linking member 20c and the second guide portion 41c of the second linking member 40c, respectively. When the rotating shaft 51c of the pinion gear 50c is caught by the longitudinal track ends of the first and second guide portions 22c and 41c, the relative movement of the first linking members 20c and 40c is restricted.

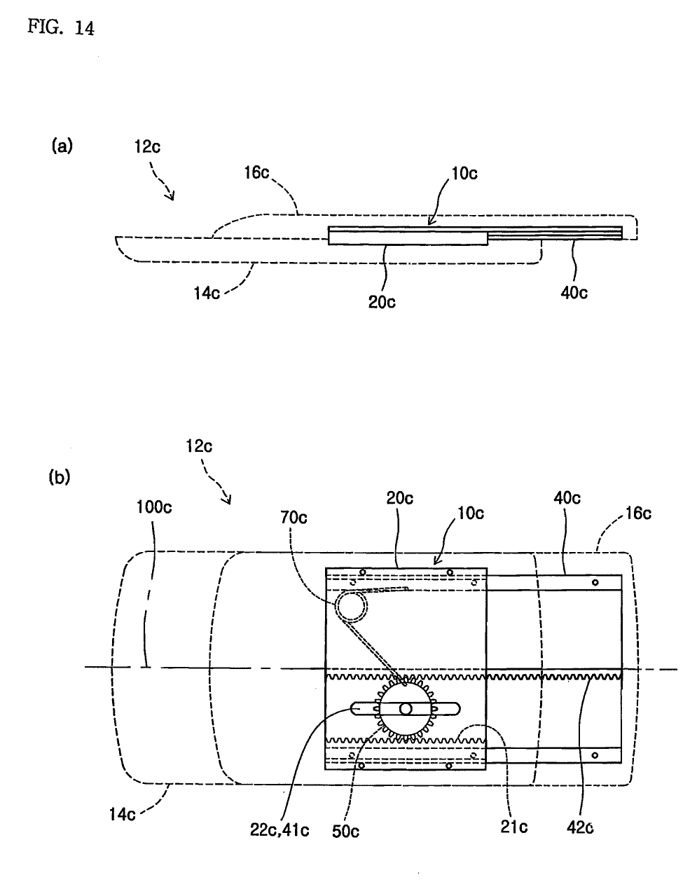

The resilient member 70c is a torsion spring. One end of the resilient member 70c is rotatably connected to the first linking member 20c and the other end thereof is rotatably connected to the first pinion gear 50c. A resilient restoring force of the resilient member 70c imparts a rotational force to the pinion gear 50c. Between the completely closed state of the portable telephone 12c shown in FIG. 11(b) and the neutral state where the portable telephone 12c is almost half opened and a distance between both ends of the resilient member 70c is minimized as shown in FIG. 14(c), the resilient member 70c imparts a rotational force to the pinion gear 50c in a direction in which the portable telephone 12c is prevented from being opened. On the contrary, between the neutral state where the portable telephone 12c is almost half opened and the distance between both ends of the resilient member 70c is minimized as shown in FIG. 14(c) and the completely open state of the portable telephone 12c shown in FIG. 15(c), the resilient member 70c imparts a rotational force to the pinion gear 50c in a direction in which the portable telephone 12c is prevented from being closed.

Now, the operation of the opening and closing apparatus 10c according to an embodiment of the present invention will be described in detail with reference to FIGS. 11, 14 and 15. FIG. 11(a) and (b) show a state where the portable telephone 12c is completely closed. At this time, the direction of the rotational force applied to the pinion gear 50c by the resilient member 70c of the opening and closing apparatus 10c corresponds to a direction in which the second linking member 40c is moved to close the portable telephone 12c. However, since the first guide portion 22c of the first linking member 20c and the second guide portion 41c of the second linking member 40c are caught in the rotating shaft 51c of the pinion gear 50c, they are limited such that they cannot be moved further toward the closing direction. At this state, the portable telephone 12c is reliably kept in a closed state of the portable telephone by means of the resilient member 70c.

In order to open the portable telephone 12c at a state shown in FIG. 11(a) and (b), an external force is applied to push the second unit 16c rightward. Then, the external force causes the second linking member 40c of the opening and closing apparatus 10c to be moved together rightward and the pinion gear 50c is also moved. A state where the portable telephone 12c is almost half opened by continuously moving the portable telephone is shown in FIG. 14(a) and (b). The state of the resilient member 70c shown in FIG. 14(a) and (b) becomes a neutral state where no rotational force is applied to the pinion gear 50c by the resilient member 70. If the external force needed for opening the portable telephone 12c is removed before the telephone is in the neutral state, the portable telephone 12c is automatically closed by means of the resilient member 70c.

If the second unit 16 is pushed rightward to further open the opening and closing apparatus 10c at a state shown in FIG. 14(a) and (b), the rotational force of the resilient member 70c of the opening and closing apparatus 10c is applied to the pinion gear 50c in a direction in which the portable telephone 12c is opened. Thereafter, the portable telephone 12c is automatically opened without additional external force and then in a state where the portable telephone 12c has been completely opened as shown in FIG. 15(a) and (b). At this time, the direction of the rotational force applied to the pinion gear 50c by the resilient member 70c of the opening and closing apparatus 10c still corresponds to a direction in which the second linking member 40c is moved to open the portable telephone 12c. However, since the first guide portion 22c of the first linking member 20c and the second guide portion 41c of the second linking member 40c are caught in the rotating shaft 51c of the pinion gear 50c, they are limited such that they cannot be moved further toward the opening direction. At this state, the portable telephone 12c is reliably kept in its open state by means of the resilient member 70c.

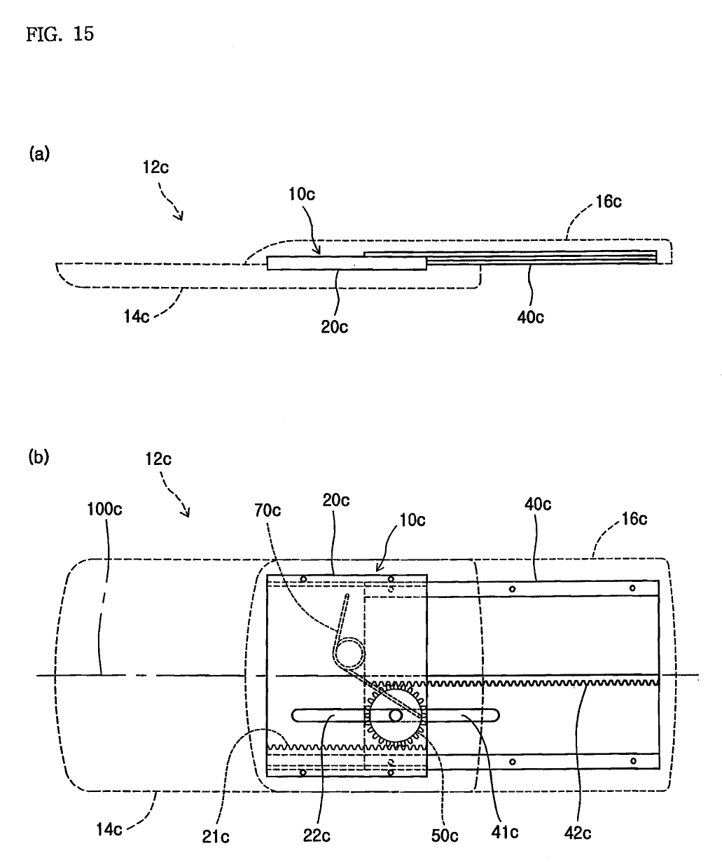

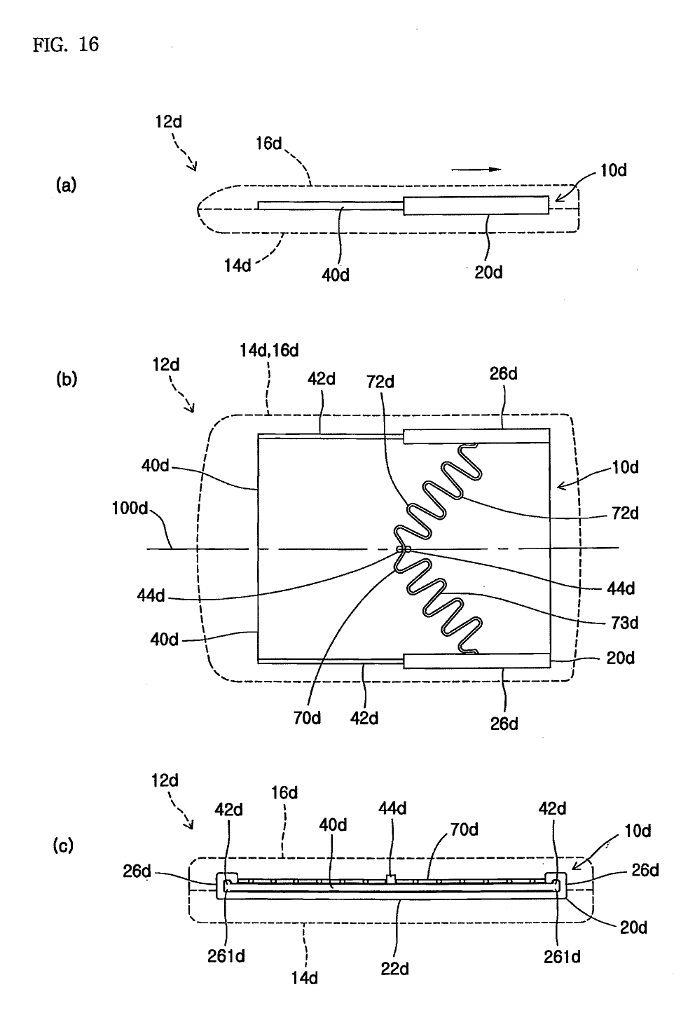

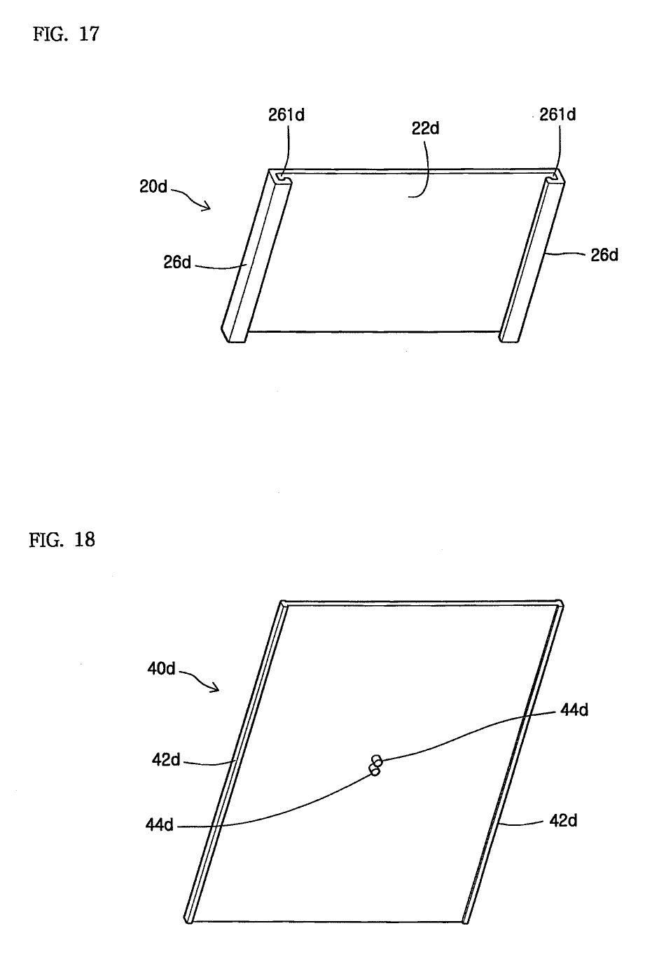

FIGS. 16 to 20 show an opening and closing apparatus 10d according to an embodiment of the present invention. Referring to FIG. 16(a) to (c), the opening and closing apparatus 10d includes a first linking member 20d linked to a first unit 14d of a portable telephone 12d, a second linking member 40d linked to a second unit 16d of the portable telephone 12d, and a resilient member 70d. Referring to FIG. 16(a) to (c) and FIG. 17, the first linking member 20d is substantially shaped as a rectangular flat plate and provided with a base plate 22d and sidewalls 26d which extend in a direction parallel to a moving axis 100d along both sides of the base plate 22d and slightly protrude toward the second unit 16d. The two sidewalls 26d are formed with linking guide grooves 261d, respectively, which face each other and extend in the direction parallel to the moving axis 100d. Two inserted portions 42d of the second linking member 40d, which will be described later, are slidably fitted into the linking guide grooves 261d, respectively. Both ends of the resilient member 70d are connected to middle points of the two sidewalls 26d above the linking guide grooves 261d, respectively.

Referring to FIG. 16(a) to (c) and FIG. 18, the second linking member 40d is substantially shaped as a rectangular flat plate which extends along the moving axis 100d, and the inserted portions 42d are formed respectively at both sides extending in a direction parallel to the moving axis 100d. The inserted portions 42d are thicker than other portions of the second linking member. The two inserted portions 42d are slidably fitted into the two linking guide grooves 261d of the first linking member 20d, respectively. In the center of the second linking member 40d are formed two protrusions 44d which protrude toward the second unit 16d of the portable telephone 12d and are substantially arranged in a longitudinal direction. The two protrusions 44d are arranged to be close to each other along the moving axis 100d. The middle part of the resilient member 70d is fitted and coupled between the two protrusions 44d.

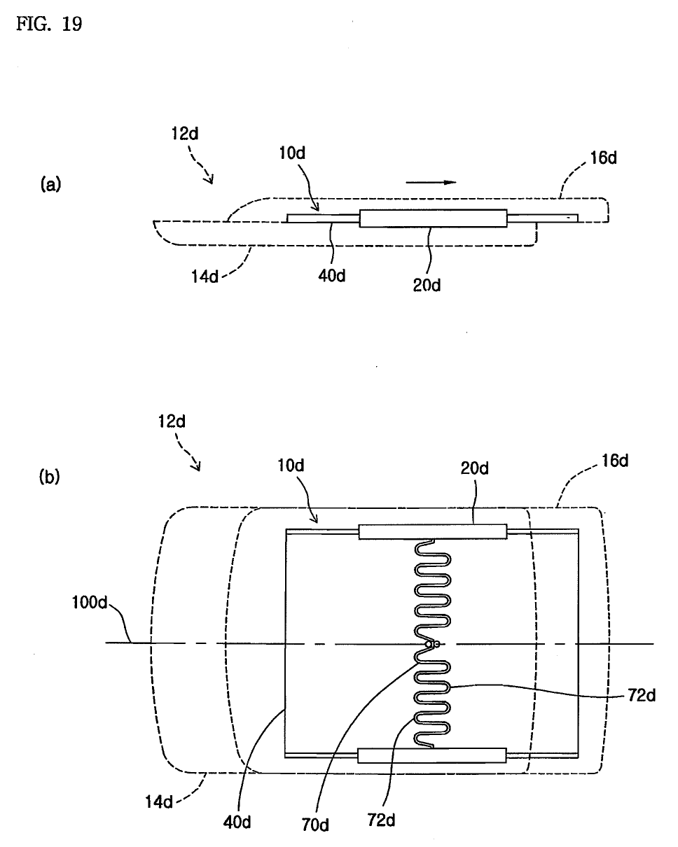

Referring to FIG. 16(b) and (c), the resilient member 70d has a zigzag shape in which a steel wire (a wire rod for spring) extends such that linear extension portions and curved portions are repeated. Accordingly, the resilient member 70d includes a plurality of curved portions 72d formed at both lateral sides thereof and a plurality of linear extension portions 73d which connect the adjacent curved portions 72d. The resilient member 70d is assembled within the linking member under a compressed state where a distance between the two adjacent curved portions 72d is decreased, and thus, the resilient member 70d functions as a compression spring. The middle portion of the resilient member 70d has a linear extension portion 73d shorter than other portions thereof, and the curved portion thereof is fitted and coupled between the two protrusions 44d of the second linking member 40d. Both ends of the resilient member 70d are fixed to the two sidewalls 26d of the first linking member 20d, respectively. The resilient member 70d is in a maximally compressed state when the resilient member 70d is substantially positioned perpendicular to the moving axis 100d as shown in FIG. 19(b). If the second linking member 40d is moved in any direction from the state shown in FIG. 19(b), the resilient member 70d imparts an elastic force to the second linking member 40d in a direction in which the second linking member 40d has been moved.

Now, the operation of the opening and closing apparatus according to an embodiment will be described in detail with reference to FIGS. 16, 19 and 20. First, FIG. 16(a) and (b) show a state where the portable telephone 12d is completely closed. At this time, the resilient member 70d is symmetrically curved with respect to the middle portion thereof that is coupled with the second linking member 40d. Since the resilient member 70d functions as a compression spring, the direction of the elastic force applied to the first and second linking members 20d and 40d by the resilient member 70d corresponds to a direction in which the portable telephone 12d is closed. However, since the portable telephone 12d has been completely closed, it is reliably kept in its closed state in such a manner that its movement is limited by a structure such as a stopper (not shown).

In order to open the portable telephone 12d at a state shown in FIG. 16(a) and (b), an external force is applied to push the second unit 16d in a direction indicated by an arrow (rightward in this figure). Then, the external force causes the second linking member 40d of the opening and closing apparatus 10d to be moved rightward with respect to the first linking member 20d, and thus, causes the resilient member 70d to be compressed. FIG. 19(a) and (b) show a state where the second unit 16d of the portable telephone 12d continues to be pushed rightward with respect to the first unit 14d and the first and second units 14d and 16d are then in a neutral position where the resilient member 70d are compressed to the utmost. If the external force is removed prior to the neutral state shown in FIG. 19(a) and (b), a restoring force of the resilient member 70d causes the second linking member 40d to be automatically moved leftward, and thus, the portable telephone 12d is automatically closed.

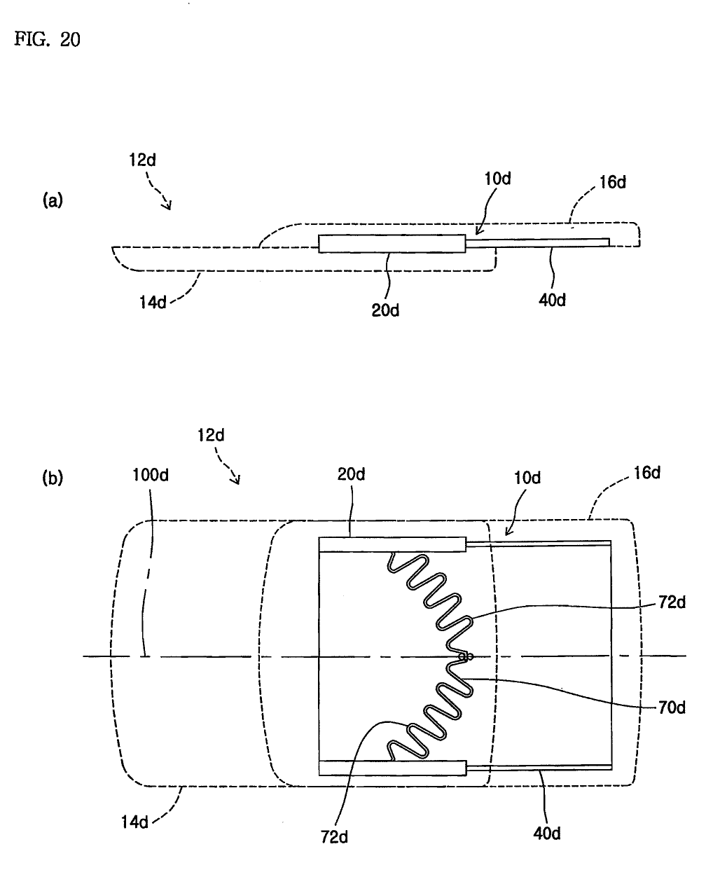

If the second unit 16d is pushed rightward with respect to the first unit 14d to further open the portable telephone 12d at a state shown in FIG. 19(a) and (b), the resilient member 70d exerts a force to move the second linking member 40d rightward relative to the first linking member 20d. This force of the resilient member 70d allows the second linking member 40d to be automatically moved rightward without any additional external force. When the portable telephone 12d is kept completely opened as shown in FIG. 20(a) and (b), the second linking member 40d is stopped by a structure such as a stopper (not shown).

Referring to FIG. 20(a) and (b), the resilient member 70d is symmetrically curved in a direction opposite to that shown in FIG. 16(b), with respect to the middle portion thereof which is coupled with the second linking member 40d. Since the resilient member 70d is a compression spring, the direction of the elastic force applied to the first and second linking members 20d and 40d by the resilient member 70d corresponds to a direction in which the first and second linking members 20d and 40d are moved to open the portable telephone 12d. However, the portable telephone 12d has been completely opened, and thus, it is reliably kept in its open state in such a manner that its movement is limited by a structure such as a stopper (not shown).

Since the opening and closing apparatus shown in FIGS. 16 to 20 employs a thin wire rod as a resilient member, there is an advantage in that the total thickness of the opening and closing apparatus can be decreased.

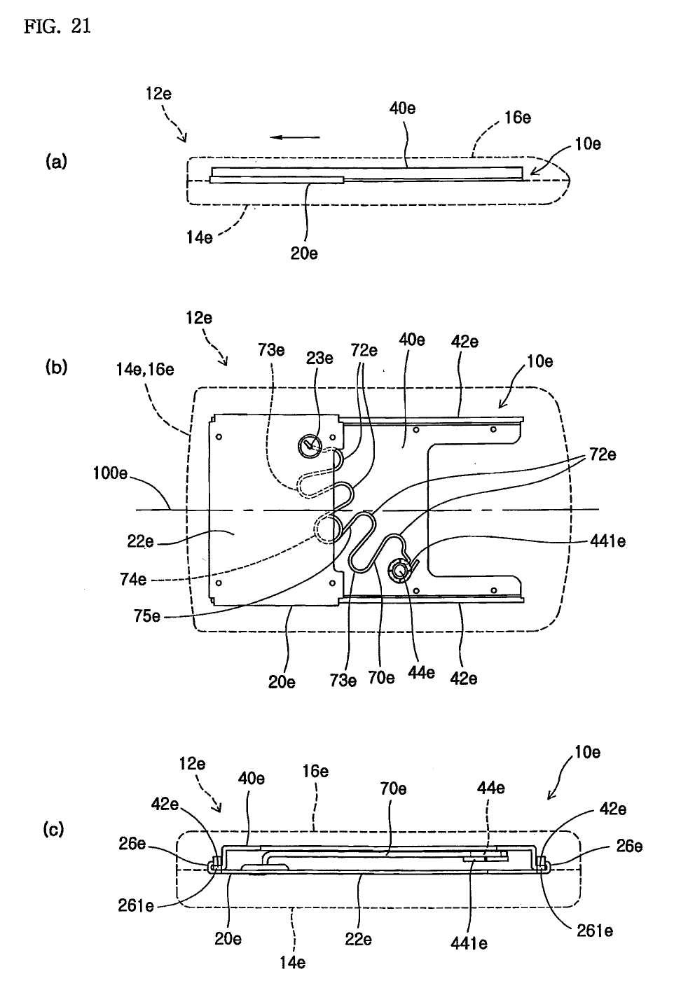

FIGS. 21 to 23 show an opening and closing apparatus 10e according to an embodiment of the present invention. Referring to FIG. 21(a) to (c), the opening and closing apparatus 10e includes a first linking member 20e linked to a first unit 14e of a portable telephone 12e, a second linking member 40e linked to a second linking member 40e of the portable telephone 12e, and a resilient member 70e. Referring to FIG. 21(a) to (c), the first linking member 20e is substantially shaped as a rectangular plate and provided with a base plate 22e and sidewalls 26e which extend in a direction parallel to a moving axis 100e along both sides of the base plate 22e and slightly protrude toward the second unit 16e. A linking hole 23e through which one end of the resilient member 70e is fitted to protrude outward is provided on a corner of the base plate 22e. A portion including this linking hole 23e protrudes toward the second linking member 40e to provide a slightly recessed space on the external surface of the base plate. One end of the resilient member 70e protruding outward through the linking hole 23e is placed within the space. The two sidewalls 26e are provided respectively with linking guide grooves 261e that face each other and extend in a direction parallel to the moving axis 100e. Two insertion wings 42e of the second linking member 40e, which will be described later, are slidably fitted into the linking guide grooves 261e, respectively.

Referring to FIG. 21(a) to (c), the second linking member 40e is substantially shaped as a rectangular plate which extends in the moving axis 100e, and each of sides parallel to the moving axis 100e is curved toward the first linking member 20e to slightly extend in such a direction and then curved once more outward, thereby resulting in the inserting wing 42e. The inserting wings 42e are slidably fitted and coupled into the two linking guide grooves 261e of the first linking member 20e, respectively. On the second linking member 40e is provided a linking column 44e that protrudes slightly toward the first linking member 20e. The linking column 44e is positioned opposite to the linking hole 23e of the first linking member 20e. The other end of the resilient member 70e is fitted and coupled around the linking column 44e. A coupling ring 441e for preventing the resilient member 70e from being separated is provided at one end of the linking column 44e.

Referring to FIG. 21(b) and (c), the resilient member 70e has a zigzag shape in which a steel wire (a wire rod for spring) extends such that linear extension portions and curved portions are repeated. Accordingly, the resilient member 70e includes a plurality of curved portions 72e, 73e and 74e formed at both lateral sides thereof and a plurality of linear extension portions 75e which connect the adjacent curved portions 72e, 73e and 74e. The radii of the curved portions 72e, 73e and 74e are relatively larger than those of the curved portions 72d of the resilient member 70d provided in the opening and closing apparatus 10d shown in FIG. 16. The curved portion 74e, which is positioned in the middle of the curved portions 73e and 74e on one lateral side among the plurality of curved portions 72e, 73e and 74e, is formed into a coil. The resilient member 70e is placed within a space defined between the first and second linking members 20e and 40e. One longitudinal end of the resilient member 70e is inserted into the linking hole 23e of the first linking member 20e to slightly protrudes outward and the protruding end is then bent to prevent the resilient member from being separated from the linking hole. The other longitudinal end of the resilient member 70e is curved into a circular shape, fitted and coupled around the linking column 44e, and prevented from being separated by the coupling ring 441e. A distance between the linking hole 23e of the first linking member 20e and the linking column 44e of the second linking member 40e is shorter than an uncompressed length of the resilient member 70e, and thus, the resilient member 70e whose both ends are connected respectively to the linking hole 23e of the first linking member 20e and the linking column 44e of the second linking member 40e is naturally curved. Therefore, an interval or gap between the two adjacent curved portions or valleys 72e positioned on one lateral side are relatively smaller than that between the two adjacent curved portions or hills 73e and 74e positioned on the other lateral side.

Among the plurality of curved portions 72e, 73e and 74e provided on both lateral sides of the resilient member 70e, the curved portions 73e and 74e of one lateral side whose interval has been relatively wider can provide an elastic force for increasing an interval between the adjacent curved portions 72e of the other lateral side. Since the radii of the curved portions 73e and 74e are relatively large and the total deformation of the resilient member 70e is distributed to the respective curved portions 73e and 74e such that stress can be distributed to the respective curved portions 73e and 74e, durability of the resilient member 70e can be improved. Accordingly, the resilient member 70e can be used for a long time. The curved portion 74e positioned in the middle of the three curved portions 73e and 74e is formed into a coil, and thus, stress can be further distributed and durability can be further improved accordingly.

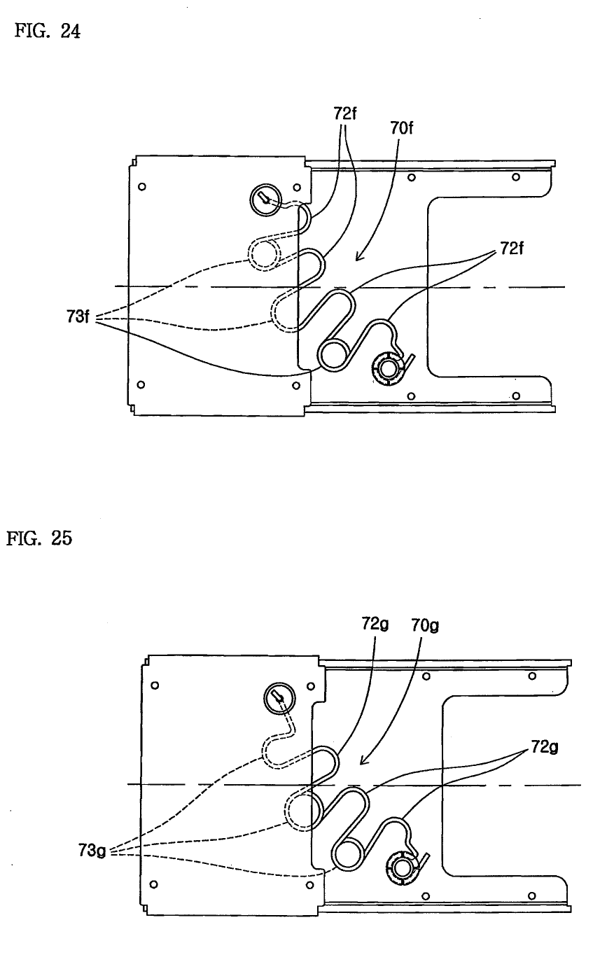

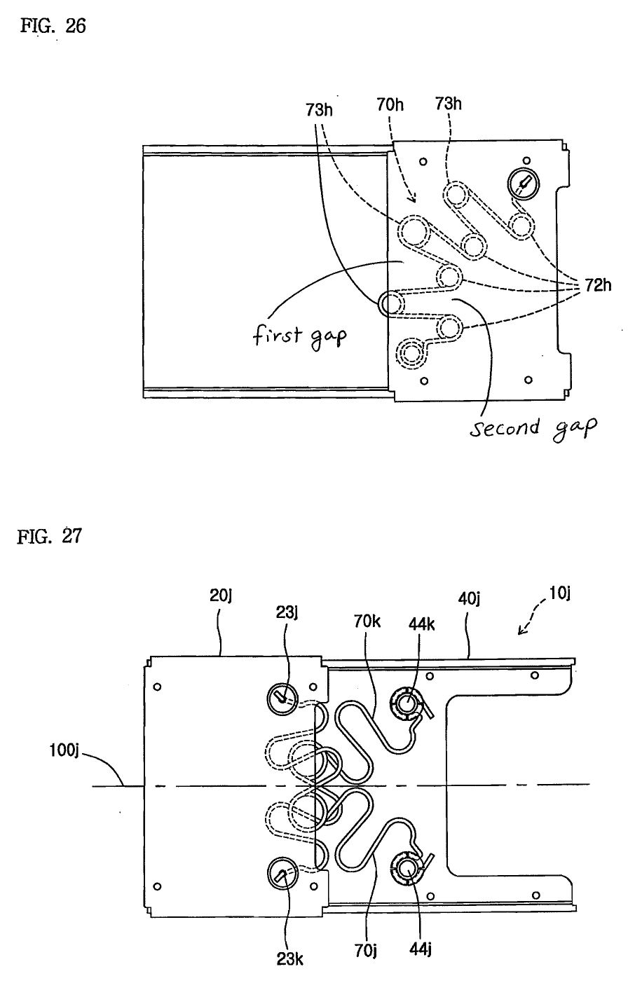

Meanwhile, although it has been described in this embodiment that the curved portion wound by one turn or two or more turns into a coil is positioned in the middle of the resilient member, the present invention is not limited thereto. The configurations in which the curved portions are formed into a coil may be changed. The examples are illustrated in FIGS. 24 to 26. Referring to FIG. 24, a resilient member 70f is configured in such a manner that the two end curved portions among the three curved portions 73f positioned on a lateral side whose interval between the adjacent curved portions is relatively larger are formed into a coil. Referring to FIG. 25, a resilient member 70g is configured in such a manner that one end curved portion and the middle curved portion among the three curved portions 73g positioned on the lateral side whose interval between the adjacent curved portions is relatively larger are formed into a coil. Referring to FIG. 26, a resilient member 70h is configured in such a manner that all curved portions 72h and 73h are formed into a coil.

Now, the operation of the opening and closing apparatus according to an embodiment will be described in detail with reference to FIGS. 21 to 23. First, FIG. 21(a) and (b) show a state where the portable telephone 12e has been completely closed. At this time, the linking column 44e of the second linking member 40e is positioned rightward along the moving axis 100e with respect to the linking hole 23e of the first linking member 20e, as viewed in the figure. The resilient member 70e is shaped as a circular arc and curved such that its center of curvature is positioned rightward on the figure. At this time, an elastic restoring force for increasing the interval between the adjacent curved portions 72e positioned at a narrow lateral side whose an interval is relatively narrower is provided in a direction in which the portable telephone 12e is closed. However, since the portable telephone 12e has been completely closed, it is reliably kept in its closed state in such a manner that its movement is limited by a structure such as a stopper (not shown).

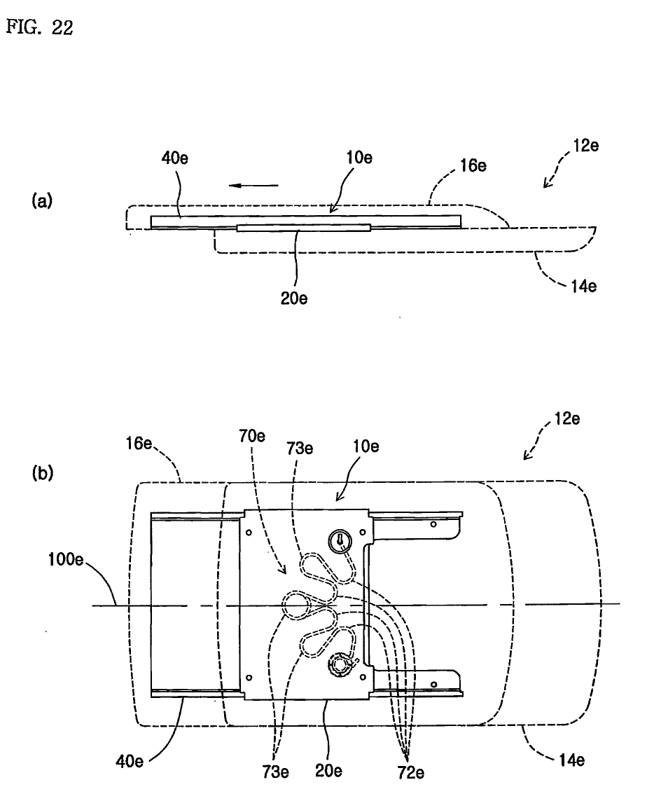

In order to open the portable telephone 12e at a state shown in FIG. 21(a) and (b), an external force is applied to push the second unit 16e in a direction indicated by an arrow (leftward in this figure). Then, the external force causes the second linking member 40e of the opening and closing apparatus 10e to be moved together leftward with respect to the first linking member 20e, and thus, the distance between both ends of the resilient member 70e is decreased. FIG. 22(a) and (b) show a state where the second unit 16e of the portable telephone 12e continues to be pushed leftward with respect to the first unit 14e and the first and second units 14e and 16e are then in a neutral position where the distance between both ends of the resilient member 70e is minimized. Referring to FIG. 22(b), the linking hole 23e of the first linking member 20e and the linking column 44e of the second linking member 40e are positioned on a line substantially perpendicular to the moving axis 100e. If the external force is removed prior to the neutral state shown in FIG. 22(a) and (b), the elastic force of the resilient member 70e causes the second linking member 40e to be automatically moved rightward, and accordingly, the portable telephone 12e is automatically closed.

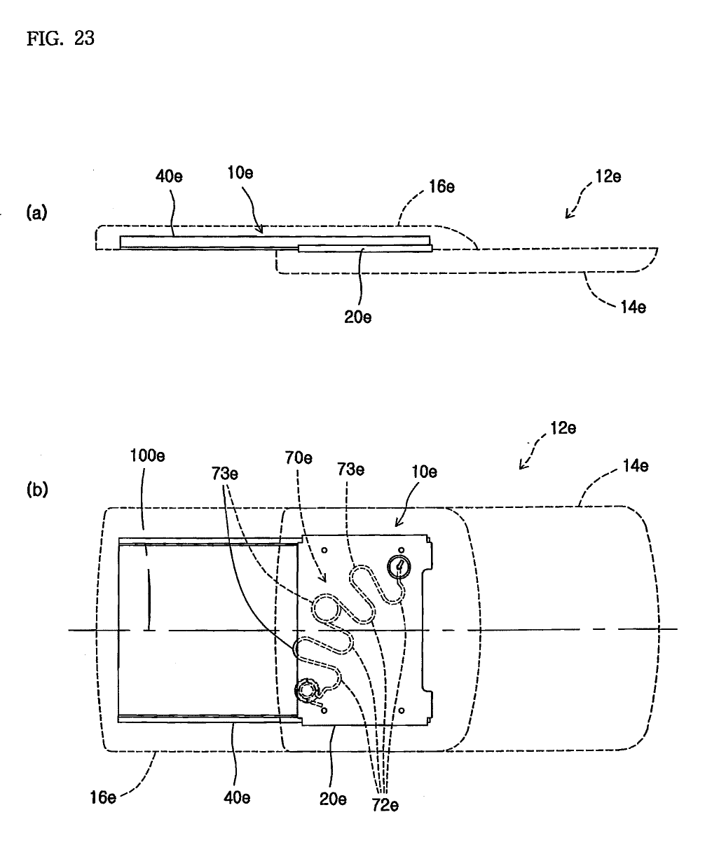

If the second unit 16e is pushed leftward with respect to the first unit 14e to further open the portable telephone 12e from a state shown in FIG. 22(a) and (b), the resilient member 70e applies a force for causing the second linking member 40e to be moved leftward with respect to the first linking member 20e. This resilient force of the resilient member 70e can cause the second linking member 40e to be automatically moved leftward without any additional external force. When the portable telephone 12e is kept completely opened as shown in FIG. 23(a) and (b), the second linking member 40e is stopped by a structure such as a stopper (not shown).

FIG. 23(a) and (b) show a state where the portable telephone 12e is completely opened. At this time, the linking column 44e of the second linking member 40e is positioned leftward along the moving axis 100e with respect to the linking hole 23e of the first linking member 20e, as viewed in the figure. The resilient member 70e is shaped as a circular arc and curved such that its center of curvature is positioned rightward on the figure. The direction of the elastic force applied to the first and second linking members 20e and 40e by the resilient member 70e corresponds to a direction in which the portable telephone 12e is opened. However, since the portable telephone 12e has been completely opened, it is reliably kept in its open state in such a manner that its movement is limited by a structure such as a stopper (not shown).

FIG. 27 shows an opening and closing apparatus 10j according to an embodiment of the present invention. Referring to FIG. 27, the opening and closing apparatus 10j includes a first linking member 20j, a second linking member 40j, and first and second resilient members 70j and 70k. The first linking member 20j has the same configuration as the first linking member 20e shown in FIG. 21, except that a second linking hole 23k positioned at a corner opposite to a first linking hole 23j is further provided. Therefore, detailed descriptions thereof will be omitted herein. One end of the second resilient member 70k is fitted and coupled into the second linking hole 23k. The second linking member 40j also has the same configuration as the second linking member 40e shown in FIG. 21, except that a second linking column 44k positioned at a side opposite to a first linking column 44j is further provided. Therefore, detailed descriptions thereof will be omitted herein. The other end of the second resilient member 70k is coupled to the second linking column 44k.

Each of the first and second resilient members 70j and 70k have the same configuration as the resilient member 70e shown in FIG. 21. That is, both ends of the first resilient member 70j are coupled to the first linking hole 23j of the first linking member 20j and the first linking column 44j of the second linking member 40j, respectively, in the same manner as shown in FIG. 21, i.e. in such a manner that the resilient members cross each other. Both ends of the second resilient member 70k are coupled to the second linking hole 23k of the first linking member 20j and the second linking column 44k of the second linking member 40j, respectively, in the same manner as the first resilient member 70j. The operation of each of the first and second resilient members 70j and 70k is the same as that of the embodiment shown in FIG. 21. However, since the respective forces applied by the two resilient members 70j and 70k in a direction perpendicular to a moving axis 100j are opposite to each other in view of their directions, force balance can be obtained. Further, since two resilient members are employed, a greater elastic force can be provided. Since the other configurations and operations are the same as those of the embodiment shown in FIG. 21, detailed descriptions thereof will be omitted herein.

Since the opening and closing apparatus 10j shown in FIG. 27 has two resilient members 70j and 70k which symmetrically cross each other, the first and second linking members are well balanced such they are not pushed toward only one side with respect to each other. Accordingly, friction generated between linking portions of the first and second linking members 20j and 40j between which the opening and closing apparatus 10j is interposed is uniform.

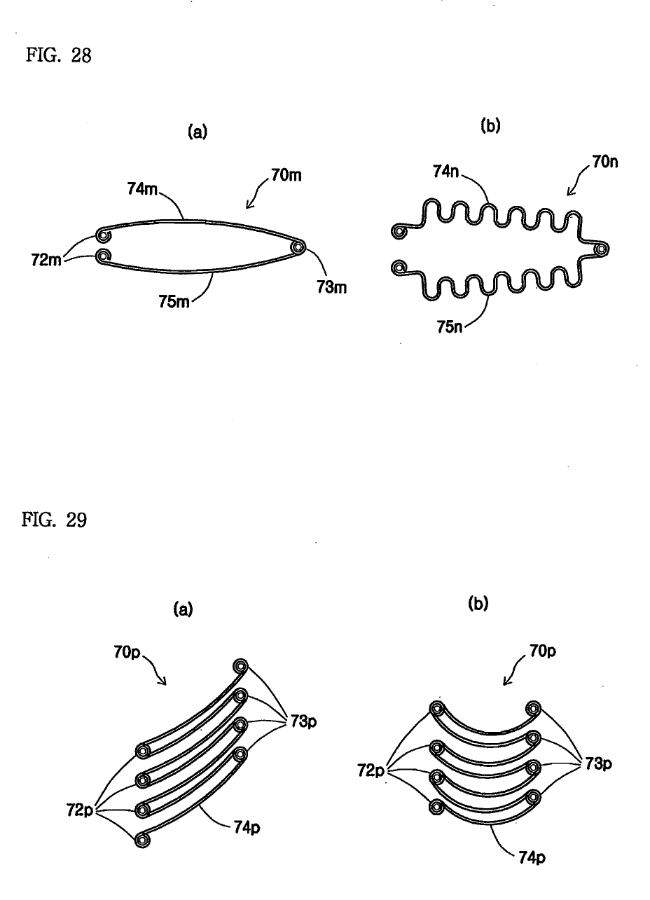

FIG. 28(a) and (b) show other embodiments of the resilient member installed to the sliding type opening and closing apparatus as shown in FIG. 21. Referring to FIG. 28(a), a resilient member 70m includes two first connecting portions 72m provided on one end thereof, a second connecting portion 73m provided on the other end, and first and second extension portions 74m and 75m for connecting the first and second connecting portions 72m and 73m. The two first connecting portions 72m are formed by circularly winding ends of the two extension portions 74m and 75m. The first and second extension portions 74m and 75m are formed from a single wire rod, and the second connecting portion 73m is formed by winding the single wire rod into a coil. The first and second extension portions 74m and 75m are curved in such a manner that their opposite sides are concave. One of the first and second connecting portions 72m and 73m is connected to the first linking member 20e of the opening and closing apparatus 10e shown in FIG. 21, whereas the other is connected to the second linking member 40e. Referring to FIG. 28(b), a resilient member 70n is configured in such a manner that first and second extension portions 74n and 75n are curved into a zigzag shape. The other configurations of the resilient member 70n are the same as those of the resilient member 70m shown in FIG. 28(a), and thus, detailed descriptions thereof will be omitted herein.

FIG. 29(a) and (b) show further embodiments of the resilient member installed in the sliding type opening and closing apparatus as shown in FIG. 21. Referring to FIG. 29(a), a resilient member 70p is formed from a single wire rod. The resilient member 70p includes a plurality of extension portions 74p which substantially have the same length as one another and extend in parallel with one another, and a plurality of first and second connecting portions 72p and 73p which are formed to be circularly wound at both ends of the plurality of extension portions. FIG. 29(a) shows a state where the extension portions 74p are maximally stretched but all of the extension portions 74p are slightly curved toward a single direction such that all the extension portions 74p can be compressed in the same direction. FIG. 29(b) shows a neutral state where the extension portions 74p are maximally compressed. One of the first and second connecting portions 72p and 73p is connected to the first linking member 20e of the sliding type opening and closing apparatus 10e shown in FIG. 21, whereas the other is connected to the second linking member 40e.

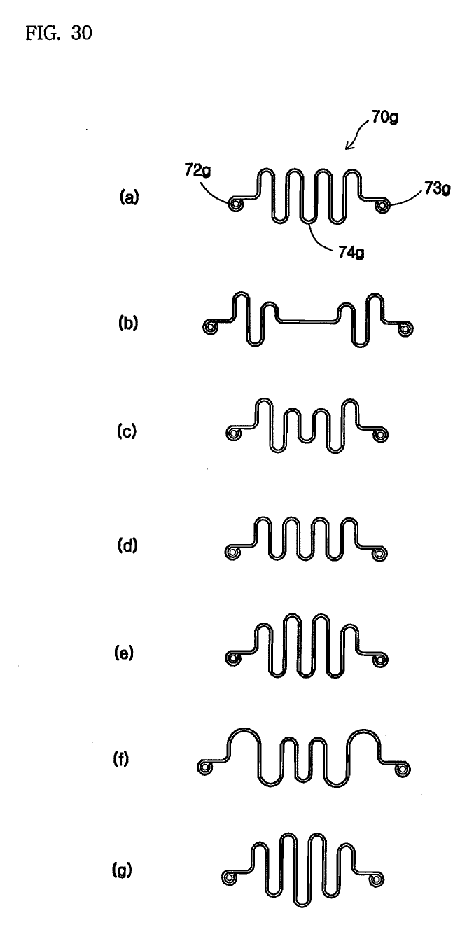

FIG. 30(a) to (g) show still further embodiments of the resilient member mounted to the sliding type opening and closing apparatus as shown in FIG. 21. Referring to FIG. 30(a), a resilient member 70g includes a curved portion 74g extending such that it is curved into a zigzag shape, and first and second connecting portions 72q and 73q provided on both ends of the curved portion 74q, respectively. One of the first and second connecting portions 72q and 73q is connected to the first linking member 20e of the sliding type opening and closing apparatus 10e shown in FIG. 21, whereas the other is connected to the second linking member 40e. The embodiments shown in FIG. 30(b) to (g) are modified examples of the embodiment shown in FIG. 30(a). Since the resilient member shown in FIG. 30 is manufactured through a manufacturing process such as a press process using a plate material, there is an advantage in that both productivity and strength can be improved.

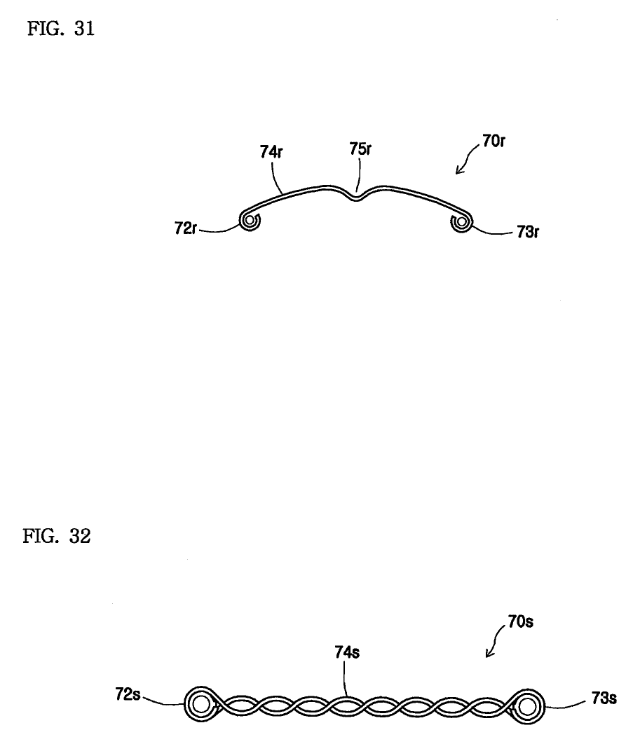

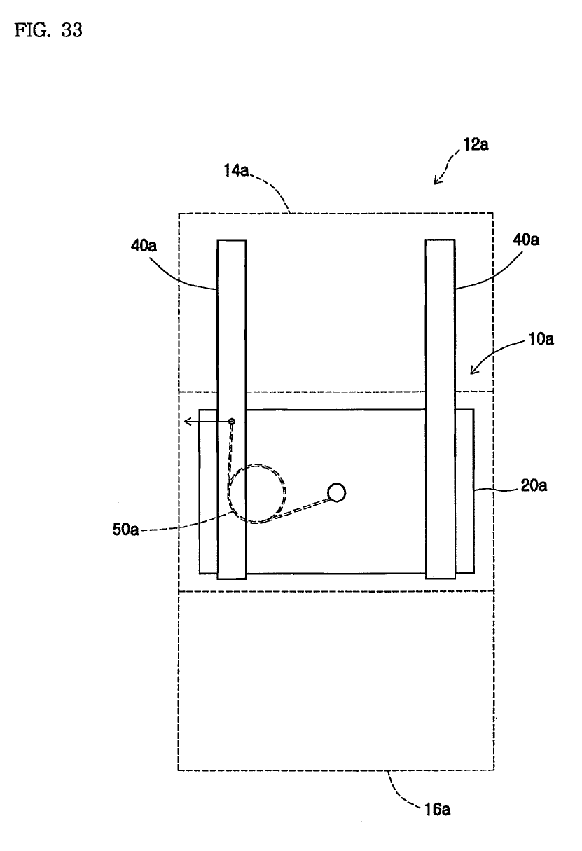

FIG. 31 shows a still further embodiment of the resilient member mounted to the sliding type opening and closing apparatus as shown in FIG. 21. Referring to FIG. 31, a resilient member 70r includes a long extension portion 74r and first and second connecting portions 72r and 73r provided at both ends of the extension portion 74r. The extension portion 74r is curved to be slightly convex upward and the middle portion of the extension portion 74r is curved to be concave downward. That is, the extension portion 74r is inclined to gradually move away from a straight line (not shown) connecting the first and second connecting portion 72r and 73r as it goes from the first and second linking portions 72r and 73r toward its middle portion. Further, a concave portion 75r is formed at the middle portion of the resilient member 70r to be curved opposite to extension portion 74r.

FIG. 32 shows a still further embodiment of the resilient member mounted to the sliding type opening and closing apparatus as shown in FIG. 21. Referring to FIG. 32, a resilient member 70s includes a long extension portion 74s formed by twisting two wire rods in a longitudinal direction, and first and second connecting portions 72s and 73s provided on both ends of the extension portion 74s.

The resilient members mounted to the opening and closing apparatuses according to the respective embodiments shown in FIGS. 16 to 32 are not limited to the same shape as shown in the figures. It can be understood by those skilled in the art that a resilient member with any shape can be employed so long as a force is applied such that a portion coupled with the first linking member can be moved away from or close to a portion coupled with the second linking member.

Although it has been described in the aforementioned embodiments that the sliding type opening and closing apparatus is mounted to the portable telephone, the present invention is not limited thereto. It will be understood by those skilled in the art that if two units which are slidably opened and closed are provided, the aforementioned opening and closing apparatus can be applied thereto.

Although embodiments of the present invention has been illustrated and described, the invention is not limited thereto. It will be understood by those skilled in the art that various modifications and changes can be made thereto without departing from the scope and spirit of the present invention and such various modifications and changes would also be included into the scope of the present invention.

What is claimed is:

1. A handheld electronic device comprising a sliding mechanism configured to interconnect a first body and a second body such that the first and second bodies are slidable with reference to the other, wherein the sliding mechanism comprises:
a first sliding member configured to be secured to the first body,
a second sliding member configured to be secured to the second body, the second sliding member slidably engaged with the first sliding member and slidable relative to the first sliding member between a first position and a second position; and
a spring comprising an undulating portion interposed between a first point and a second point of the spring's wire, the first point being secured to the first sliding member, the second point being secured to the second sliding member, wherein the undulating portion is configured to be compressed and released as the first sliding member slides between the first and second positions.

2. The device of claim 1, wherein the undulating portion comprises a plurality of alternating hills and valleys, wherein two immediately neighboring hills form a first gap therebetween, and two immediately neighboring valleys form a second gap therebetween.

3. The device of claim 2, wherein at least part of the hills and valleys comprises a U-turn of the wire.

4. The device of claim 2, wherein at least part of the hills and valleys comprises a circular turning of the wire.

5. The device of claim 2, wherein the hills and valleys are generally in the same size.

6. The device of claim 2, wherein at least one of the hills and valleys has a size significantly different from another of the hills and valleys.

7. The device of claim 2, wherein the undulating portion is configured such that the second gap becomes smaller as the undulating portion is compressed.

8. The device of claim 7, wherein the undulating portion is configured such that the first gap becomes larger as the second gap becomes smaller.

9. The device of claim 8, wherein at least one of the hills comprises a circular turning of the wire.

10. The device of claim 7, wherein the first gap is the largest when the first sliding member is at the first or second position.

11. The device of claim 2, wherein the undulating portion further comprises a plurality of extensions, each between a hill and a valley immediately neighboring the hill.

12. The device of claim 11, wherein the plurality of extensions are in generally the same length.

13. The device of claim 11, wherein at least one of the plurality of extensions has a length significantly different from another of the plurality of extensions.

14. The device of claim 11, wherein at least part of the plurality of extensions is substantially straight.

15. The device of claim 11, wherein at least two of the plurality of extensions are generally curved while generally parallel with each other.

16. The device of claim 1, wherein the spring comprises the undulating portion substantially throughout between the first and second points.

17. The device of claim 1, wherein the undulating portion is only a part between the first and second points of the spring.

18. The device of claim 1, wherein the spring comprises at least one additional undulating portion between the first and second points.

19. The device of claim 1, wherein the spring further comprises at least one circular turning between the first and second points.

20. The device of claim 1, wherein the undulating portion comprises a plurality of first U-turns and a plurality of second U-turns generally in an opposite direction of the plurality of first U-turns, wherein the plurality of first and second U-turns are alternatingly arranged such that two neighboring first U-turns form a first gap therebetween and two neighboring second U-turns form a second gap therebetween.

21. The device of claim 1, wherein the wire of the spring is press-produced.

22. The device of claim 1, wherein the undulating portion is substantially in a single plane.

23. The device of claim 16, wherein the undulating portion is configured to be compressed and released while substantially staying in the single plane.

24. The device of claim 1, wherein the spring comprises another undulating portion interposed between the second point and a third point of the spring's wire, the third point being secured to the first sliding member, wherein the additional undulating portion is configured to be compressed and released as the first sliding member slides between the first and second positions.
